(19) United States
(12) Patent Application Publication
(10) Pub. No.: US 2025/0217881 A1
(43) Pub. Date: Jul. 3, 2025

(54) MACHINE LEARNING BASED SYSTEMS AND METHODS FOR CREDIT RISK MANAGEMENT

(71) Applicant: HIGHRADIUS CORPORATION, Houston, TX (US)

(72) Inventors: MAHEK MAHENDRA SHAH, Hyderabad (IN); SOWMYA KILAMBI, Hyderabad (IN); BRAHMA PRAKASH CHARY DEEGUTLA, Hyderabad (IN); HARKIRAT SINGH, Hyderabad (IN); BHARAT CHANDRA TEEPALAPUDI, Hyderabad (IN); JASWINDER SINGH, Hyderabad (IN); RISHABH SETHIYA, Hyderabad (IN); SHIVENDRA SRIVASTAVA, Hyderabad (IN); DEEPALI PANDEY, Hyderabad (IN); HARIKA YENUGU, Hyderabad (IN); SURYA VADLAMANI, Hyderabad (IN)

(21) Appl. No.: 18/399,766

(22) Filed: Dec. 29, 2023

(51) Int. Cl. G06Q 40/03; G06N 20/20

(52) U.S. Cl. CPC G06Q 40/03; G06N 20/20

(57) ABSTRACT

A machine learning based computing method for automatic managing credit risks of first users, is disclosed. The machine learning based computing method includes: receiving inputs from electronic devices associated with second users; retrieving data associated with first users from databases; preprocessing the data to remove noises, outliers, and missing values, from datasets; determining, the credit risks of the entities based on the pre-processed data by machine learning models; generating credit decisions for the entities; generating confidence scores for credit decisions to classify the credit decisions, based on correlation between the data and credit decisions; determining recommended credit values, recommended first credit limits, and recommended second credit limits, based on classification of the credit decisions; and providing an output of the credit decisions, the recommended credit values and the recommended credit limits, to the second users on user interfaces associated with electronic devices.

### FIELD OF INVENTION

Embodiments of the present disclosure relate to machine learning based (ML-based) computing systems, and more particularly relates to a ML-based computing method and system for managing one or more credit risks of one or more first users.

### BACKGROUND

Credit risk management typically involves analyzing the probability that a borrower or counterparty may fail to meet their financial obligations. This analysis is a crucial aspect of effective credit risk management, equipping lenders and financial entities with one or more tools to assess, monitor, and mitigate potential losses arising from credit risk. A key element in this process involves determining credit risk limit, which essentially represents the highest amount of credit a customer can obtain or access, determined by their creditworthiness and financial behavior. Performing timely and periodic credit risk assessments is important for businesses due to the following reasons.

The credit risk assessment helps the businesses to make well-informed lending choices by considering the creditworthiness of their customers and evaluating the risk-return trade-off for each sales or purchase decision. The credit risk assessment further helps the businesses to manage their credit portfolio and to spread credit risk across various segments, industries, geographies, and products. The credit risk assessment further helps the businesses to comply with regulatory requirements and standards for credit risk management. The credit risk assessment further helps the businesses to identify and address credit weaknesses and emerging risks in a timely manner. The credit risk assessment further helps the businesses lend credit fairly through data assisted modelling and decisioning processes, while bringing standardization of credit practices across geographies.

Credit teams encounter numerous challenges in their operations. A notable issue involves a common occurrence of reactive reviews in credit risk management, where assessments are conducted in response to events rather than being conducted proactively. Another significant issue involves delayed credit limit upgrades for the customers in good standing, which could potentially hinder sales and overall business performance. Similarly, procrastination in credit limit downgrades for delinquent customers poses a risk, contributing to high-risk credit exposure and increased bad debt.

Moreover, the frequent occurrence of monthly, quarterly, and annual reviews results in a mounting backlog for credit teams, underscoring a need for a more efficient review system. The increasing volume of alerts from credit agencies adds complexity, with the challenge of distinguishing critical alerts, including bankruptcy filings, from less impactful events including company-sponsored events. Additionally, the differentiation between the creditworthiness and payment behavior demands meticulous manual consideration by financial analysts.

Finally, in industries characterized by prolonged time intervals between order placement and delivery, including an industrial and manufacturing sector, there arises a necessity for pre-emptive credit reviews before delivery dates to alleviate potential risks. Addressing these challenges is imperative for optimizing credit management processes and ensuring the financial well-being of the business.

Hence, there is a need for an improved machine learning based (ML-based) computing system and method for managing one or more credit risks of one or more first users, in order to address the aforementioned issues.

### SUMMARY

This summary is provided to introduce a selection of concepts, in a simple manner, which is further described in the detailed description of the disclosure. This summary is neither intended to identify key or essential inventive concepts of the subject matter nor to determine the scope of the disclosure.

In accordance with an embodiment of the present disclosure, a machine-learning based (ML-based) computing method for managing one or more credit risks of one or more first users, is disclosed. The ML-based computing method comprises receiving, by one or more hardware processors, one or more inputs from one or more electronic devices associated with one or more second users. The one or more inputs comprise one or more information related to at least one of: one or more entities associated with the one or more first users.

The ML-based computing method further comprises retrieving, by the one or more hardware processors, one or more data associated with the one or more first users from one or more databases, based on the one or more inputs received from the one or more electronic devices associated with the one or more second users. The one or more data comprise at least one of: one or more credit agency data, one or more accounts receivables data, one or more financial metrics, and one or more entity data, associated with the one or more first users.

The ML-based computing method further comprises preprocessing, by the one or more hardware processors, the one or more data to remove at least one of: one or more noises, one or more outliers, and one or more missing values, from one or more datasets comprising the one or more data. The one or more data are pre-processed to at least one of: normalize and standardize the one or more data to be consistent and compatible based on one or more first pre-configured rules and parameters.

The ML-based computing method further comprises determining, by the one or more hardware processors, the one or more credit risks of the one or more entities associated with the one or more first users based on the preprocessed one or more data, by one or more machine learning models.

The ML-based computing method further comprises generating, by the one or more hardware processors, one or more credit decisions for the one or more entities associated with the one or more first users based on the determined one or more credit risks of the one or more entities associated with the one or more first users, by the one or more machine learning models. The one or more credit decisions comprise at least one of: one or more first credit decisions, one or more second credit decisions, one or more third credit decisions.

The ML-based computing method further comprises generating, by the one or more hardware processors, one or more confidence scores for each credit decision of the one or more credit decisions to classify the one or more credit decisions, based on a correlation between the one or more data and the one or more credit decisions. The classification of the one or more credit decisions comprises at least one of: one or more first credit decisions, one or more second credit decisions, one or more third credit decisions.

The ML-based computing method further comprises determining, by the one or more hardware processors, at least one of: one or more recommended credit values, one or more recommended first credit limits, and one or more recommended second credit limits, based on the classification of at least one of: the one or more first credit decisions, the one or more second credit decisions, the one or more third credit decisions.

The ML-based computing method further comprises providing, by the one or more hardware processors, one or more automated approvals for the one or more credit decisions, based on one or more second pre-configured rules and parameters.

The ML-based computing method further comprises providing, by the one or more hardware processors, an output of at least one of: the one or more credit decisions, the one or more recommended credit values, the one or more recommended first credit limits, and the one or more recommended second credit limits, to the one or more second users on one or more user interfaces associated with the one or more electronic devices.

In an embodiment, the ML-based computing method further comprises retrieving, by the one or more hardware processors, one or more current credit limits and maintaining the one or more current credit limits, for the one or more entities associated with the one or more first users when the one or more third credit decisions are generated.

In another embodiment, at least one of; the one or more recommended first credit limits, and the one or more recommended second credit limits, are determined upon generation of at least one of: the one or more first credit decisions and the one or more second credit decisions, based on one or more key statistical parameters, wherein the one or more key statistical parameters comprise at least one of: the one or more current credit limits, median, and standard deviation. The one or more current credit limits are associated with one or more reference points when the median and the standard deviation provide one or more insights into a central tendency and variability of the one or more data.

In yet another embodiment, the one or more recommended credit values are determined by adding one or more scaled values of the standard deviation to the one or more current credit limits, with one or more first scaling factors associated with one or more first configurable statistical variables, when the one or more first credit decisions are generated. The one or more recommended first credit limits are determined by adding the one or more scaled values of the standard deviation to the one or more current credit limits, with one or more second scaling factors associated with one or more second configurable statistical variables, when the one or more first credit decisions are generated. The one or more recommended third credit limits are determined by at least one of: adding the one or more scaled values of the standard deviation to the one or more current credit limits, with one or more third scaling factors associated with one or more third configurable statistical variables, when the one or more first credit decisions are generated.

In yet another embodiment, the one or more recommended credit values are determined by subtracting the one or more scaled values of the standard deviation to the one or more current credit limits, with the one or more first scaling factors associated with the one or more first configurable statistical variables, when the one or more second credit decisions are generated. The one or more recommended first credit limits are determined by subtracting the one or more scaled values of the standard deviation to the one or more current credit limits, with the one or more second scaling factors associated with the one or more second configurable statistical variables, when the one or more second credit decisions are generated. The one or more recommended third credit limits are determined by at least one of: subtracting the one or more scaled values of the standard deviation to the one or more current credit limits, with the one or more third scaling factors associated with the one or more third configurable statistical variables, when the one or more second credit decisions are generated.

In yet another embodiment, the ML-based computing method further comprises training, by the one or more hardware processors, the one or more machine learning models, by: (a) obtaining, by the one or more hardware processors, one or more labelled datasets from the one or more databases; (b) selecting, by the one or more hardware processors, one or more features associated with the one or more data for training the one or more machine learning models based on one or more feature engineering processes; (c) segmenting, by the one or more hardware processors, the one or more labelled datasets into at least one of: one or more training datasets and one or more validation datasets; (d) training, by the one or more hardware processors, the one or more machine learning models to correlate the one or more features associated with the one or more data, with one or more historical credit decisions; and (e) generating, by the one or more hardware processors, the one or more confidence scores for each credit decision of the one or more credit decisions, based on the trained one or more machine learning models.

In an embodiment, The one or more labelled datasets comprise the one or more data. The one or more feature engineering processes comprise at least one of: a forward feature selection process, a backward feature selection process, an exhaustive feature selection process, a recursive feature elimination process, a random forest importance process and a boosted feature extractor process. The one or more historical credit decisions comprises at least one of: one or more first historical credit decisions, one or more second historical credit decisions, one or more third historical credit decisions. The one or more machine learning models comprise at least one of: a random forest model, an extreme gradient boosting (XGBoost) classifier model, a K-means clustering model, a light gradient-boosting machine (LightGBM) classifier model.

In yet another embodiment, the ML-based computing method further comprises validating, by the one or more hardware processors, the one or more machine learning models based on the one or more validation datasets by determining, by the one or more hardware processors, whether one or more metric scores attained by the trained machine learning model, exceeds one or more pre-determined threshold values. The one or more metric scores are associated with one or more validation metrics comprising at least one of: precision metric, recall metric, and F1-score metric.

In yet another embodiment, the ML-based computing method further comprises adjusting, by the one or more hardware processors, one or more hyperparameters to fine-tune the one or more machine learning models based on one or more results of validation of the one or more machine learning models.

In yet another embodiment, the ML-based computing method further comprises re-training, by the one or more hardware processors, the one or more machine learning models over a plurality of time intervals based on one or more training data by: (a) receiving, by the one or more hardware processors, the one or more training data corresponding to the one or more data associated with the one or more second users; (b) adding, by the one or more hardware processors, the one or more training data with the one or more labelled datasets to generate one or more updated training datasets; (c) re-training, by the one or more hardware processors, the one or more machine learning models to correlate the one or more features associated with the one or more data, with the one or more historical credit decisions; and (d) executing, by the one or more hardware processors, the re-trained machine learning models in a credit decision generation subsystem to generate the one or more credit decisions for the one or more entities associated with the one or more first users.

In one aspect, a machine learning based (ML-based) computing system for managing one or more credit risks of one or more first users, is disclosed. The ML-based computing system includes one or more hardware processors and a memory coupled to the one or more hardware processors. The memory includes a plurality of subsystems in the form of programmable instructions executable by the one or more hardware processors.

The plurality of subsystems comprises an input receiving subsystem configured to receive one or more inputs from one or more electronic devices associated with one or more second users. The one or more inputs comprise one or more information related to at least one of: one or more entities associated with the one or more first users.

The plurality of subsystems further comprises a data retrieval subsystem configured to retrieve one or more data associated with the one or more first users from one or more databases, based on the one or more inputs received from the one or more electronic devices associated with the one or more second users. The one or more data comprise at least one of; one or more credit agency data, one or more accounts receivables data, one or more financial metrics, and one or more entity data, associated with the one or more first users.

The plurality of subsystems further comprises a data preprocessing subsystem configured to preprocess the one or more data to remove at least one of: one or more noises, one or more outliers, and one or more missing values, from one or more datasets comprising the one or more data. The one or more data are preprocessed to at least one of: normalize and standardize the one or more data to be consistent and compatible based on one or more first pre-configured rules and parameters.

The plurality of subsystems further comprises a credit risk determining subsystem configured to determine the one or more credit risks of the one or more entities associated with the one or more first users based on the preprocessed one or more data, by one or more machine learning models.

The plurality of subsystems further comprises a credit decision generation subsystem configured to generate one or more credit decisions for the one or more entities associated with the one or more first users based on the determined one or more credit risks of the one or more entities associated with the one or more first users, by the one or more machine learning models.

The plurality of subsystems further comprises a confidence score generation subsystem configured to generate one or more confidence scores for each credit decision of the one or more credit decisions to classify the one or more credit decisions, based on a correlation between the one or more data and the one or more credit decisions. The classification of the one or more credit decisions comprises at least one of: one or more first credit decisions, one or more second credit decisions, one or more third credit decisions.

The plurality of subsystems further comprises a credit limit determining subsystem configured to determine at least one of: one or more recommended credit values, one or more recommended first credit limits, and one or more recommended second credit limits, based on the classification of at least one of: the one or more first credit decisions, the one or more second credit decisions, the one or more third credit decisions.

The plurality of subsystems further comprises an auto-approval subsystem configured to provide one or more automated approvals for the one or more credit decisions, based on one or more second pre-configured rules and parameters.

The plurality of subsystems further comprises an output subsystem configured to provide an output of at least one of: the one or more credit decisions, the one or more recommended credit values, the one or more recommended first credit limits, and the one or more recommended second credit limits, to one or more second users on one or more user interfaces associated with the one or more electronic devices.

In another aspect, a non-transitory computer-readable storage medium having instructions stored therein that, when executed by a hardware processor, causes the processor to perform method steps as described above.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF DRAWINGS

The disclosure will be described and explained with additional specificity and detail with the accompanying figures in which:

FIG. 1 is a block diagram illustrating a computing environment with a machine learning based (ML-based) computing system for managing one or more credit risks of one or more first users, in accordance with an embodiment of the present disclosure;

FIG. 2 is a detailed view of the ML-based computing system for managing the one or more credit risks of the one or more first users, in accordance with another embodiment of the present disclosure:

FIG. 3 is a process flow of training one or more machine learning models (e.g., one or more fine-tuned multi-classification based machine learning models) for managing the one or more credit risks of the one or more first users, in accordance with an embodiment of the present disclosure;

FIG. 4 are exemplary graphical representations depicting an output of at least one of: the one or more credit decisions on one or more user interfaces associated with one or more electronic devices, in accordance with an embodiment of the present disclosure; and

FIG. 5 is an flow chart illustrating a machine-learning based (ML-based) computing method for managing the one or more credit risks of the one or more first users, in accordance with an embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION OF THE DISCLOSURE

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure. It will be understood by those skilled in the art that the foregoing general description and the following detailed description are exemplary and explanatory of the disclosure and are not intended to be restrictive thereof.

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

The terms “comprise”, “comprising”, or any other variations thereof, are intended to cover a non-exclusive inclusion, such that one or more devices or sub-systems or elements or structures or components preceded by “comprises . . . a” does not, without more constraints, preclude the existence of other devices, sub-systems, additional sub-modules. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

A computer system (standalone, client or server computer system) configured by an application may constitute a “module” (or “subsystem”) that is configured and operated to perform certain operations. In one embodiment, the “module” or “subsystem” may be implemented mechanically or electronically, so a module includes dedicated circuitry or logic that is permanently configured (within a special-purpose processor) to perform certain operations. In another embodiment, a “module” or “subsystem” may also comprise programmable logic or circuitry (as encompassed within a general-purpose processor or other programmable processor) that is temporarily configured by software to perform certain operations.

Accordingly, the term “module” or “subsystem” should be understood to encompass a tangible entity, be that an entity that is physically constructed, permanently configured (hardwired) or temporarily configured (programmed) to operate in a certain manner and/or to perform certain operations described herein.

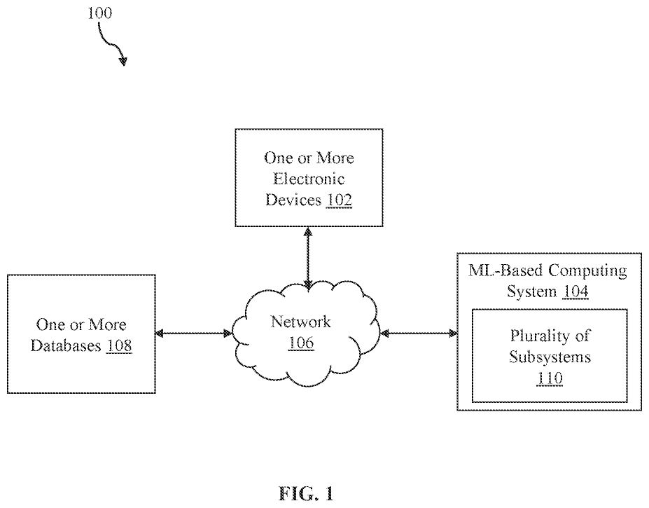

Referring now to the drawings, and more particularly to FIG. 1 through FIG. 5, where similar reference characters denote corresponding features consistently throughout the figures, there are shown preferred embodiments and these embodiments are described in the context of the following exemplary system and/or method.

FIG. 1 is a block diagram illustrating a computing environment 100 with a machine learning based (ML-based) computing system 104 for managing one or more credit risks of one or more first users, in accordance with an embodiment of the present disclosure. According to FIG. 1, the computing environment 100 includes one or more electronic devices 102 that are communicatively coupled to the ML-based computing system 104 through a network 106. The one or more electronic devices 102 through which one or more second users provide one or more inputs to the ML-based computing system 104.

In an embodiment, the one or more second users may include at least one of: one or more data analysts, one or more business analysts, one or more credit analysts, one or more cash analysts, one or more financial analysts, one or more collection analysts, one or more debt collectors, one or more professionals associated with credit, cash and collection management, and the like.

The present invention is configured to manage the one or more credit risks of the one or more first users by at least one of: generating one or more credit decisions for one or more entities associated with the one or more first users and determining/generating at least one of: one or more recommended credit values, one or more recommended first credit limits, and one or more recommended second credit limits. The ML-based computing system 104 is initially configured to receive one or more inputs from the one or more electronic devices 102 associated with one or more second users. In an embodiment, the one or more inputs may include one or more information related to at least one of: the one or more entities associated with the one or more first users. In an embodiment, the one or more entities may include at least one of: one or more organizations, one or more corporations, one or more parent companies, one or more subsidiaries, one or more joint ventures, one or more partnerships, one or more governmental bodies, one or more associations, one or more legal entities, and the like.

The ML-based computing system 104 is further configured to retrieve one or more data associated with the one or more first users from one or more databases 108, based on the one or more inputs received from the one or more electronic devices 102 associated with the one or more second users. In an embodiment, the one or more data may include at least one of; one or more credit agency data, one or more accounts receivables data, one or more financial metrics, one or more entity data, and the like, associated with the one or more first users. In an embodiment, the one or more data associated with the one or more first users, may be encrypted and decrypted by the ML-based computing system 104 so that one or more third party users cannot be authenticated to manipulate the one or more data.

The ML-based computing system 104 is further configured to preprocess the one or more data to remove at least one of: one or more noises, one or more outliers, and one or more missing values, from one or more datasets including the one or more data. In an embodiment, the one or more data are preprocessed to at least one of: normalize and standardize the one or more data to be consistent and compatible based on one or more first pre-configured rules and parameters. The ML-based computing system 104 is further configured to determine the one or more credit risks of the one or more entities associated with the one or more first users based on the preprocessed one or more data, by one or more machine learning models. In an embodiment, the one or more machine learning models may be one or more fine-tuned multi-classification based machine learning models. In an embodiment, the terms “one or more machine learning models” and “one or more fine-tuned multi-classification based machine learning models” may be used interchangeably in the subsequent paragraphs.

The ML-based computing system 104 is further configured to generate one or more credit decisions for the one or more entities associated with the one or more first users based on the determined one or more credit risks of the one or more entities associated with the one or more first users, by the one or more fine-tuned multi-classification based machine learning models. The one or more credit decisions may include at least one of: one or more first credit decisions (e.g., one or more credit upgrade decisions), one or more second credit decisions (e.g., one or more credit downgrade decisions), one or more third credit decisions (e.g., one or more credit extension decisions). The ML-based computing system 104 is further configured to generate one or more confidence scores for each credit decision of the one or more credit decisions to classify the one or more credit decisions, based on a correlation between the one or more data and the one or more credit decisions. The classification of the one or more credit decisions may include at least one of: the one or more first credit decisions (e.g., the one or more credit upgrade decisions), the one or more second credit decisions (e.g., the one or more credit downgrade decisions), the one or more third credit decisions (e.g., the one or more credit extension decisions).

The ML-based computing system 104 is further configured to determine at least one of: one or more recommended credit values, one or more recommended first credit limits (e.g., one or more recommended upper credit limits), and one or more recommended second credit limits (e.g., one or more recommended lower credit limits), based on the classification of at least one of the one or more first credit decisions, the one or more second credit decisions, the one or more third credit decisions. The ML-based computing system 104 is further configured to provide one or more automated approvals for the one or more credit decisions, based on one or more second pre-configured rules and parameters. The ML-based computing system 104 is further configured to provide an output of at least one of the one or more credit decisions, the one or more recommended credit values, the one or more recommended first credit limits, and the one or more recommended second credit limits, to the one or more second users on one or more user interfaces associated with the one or more electronic devices 102.

The ML-based computing system 104 may be hosted on a central server including at least one of: a cloud server or a remote server. In an embodiment, the ML-based computing system 104 may include at least one of a user device, a server computer, a server computer over the network 106, a cloud-based computing system, a cloud-based computing system over the network 106, a distributed computing system, and the like. Further, the network 106 may be at least one of a Wireless-Fidelity (Wi-Fi) connection, a hotspot connection, a Bluetooth connection, a local area network (LAN), a wide area network (WAN), any other wireless network, and the like. In an embodiment, the one or more electronic devices 102 may include at least one of: a laptop computer, a desktop computer, a tablet computer, a Smartphone, a wearable device, a Smart watch, and the like.

Further, the computing environment 100 includes the one or more databases 108 communicatively coupled to the ML-based computing system 104 through the network 106. In an embodiment, the one or more databases 108 include at least one of: one or more relational databases, one or more object-oriented databases, one or more data warehouses, one or more cloud-based databases, and the like. In another embodiment, a format of the one or more data retrieved from the one or more databases 108 may include at least one of a comma-separated values (CSV) format, a JavaScript Object Notation (JSON) format, an Extensible Markup Language (XML), spreadsheets, and the like. Furthermore, the one or more electronic devices 102 include at least one of: a local browser, a mobile application, and the like.

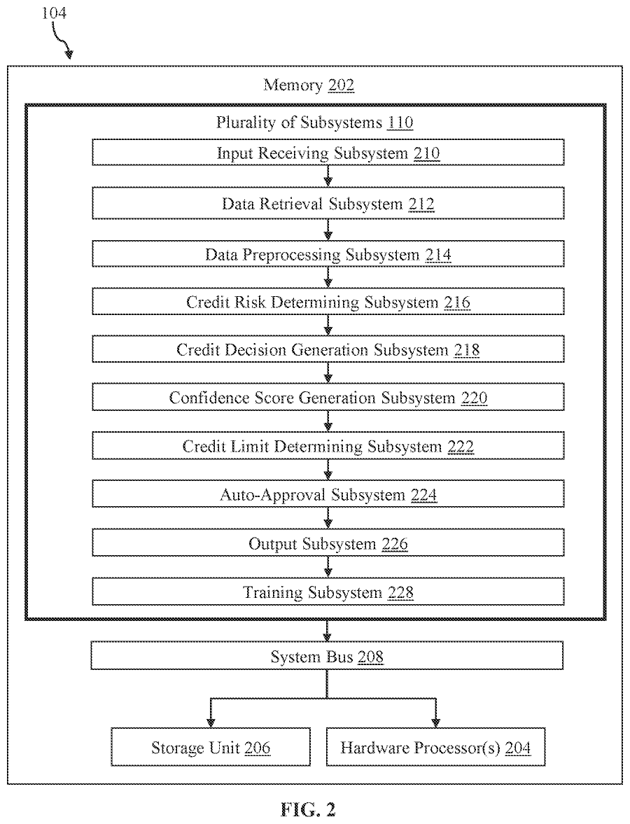

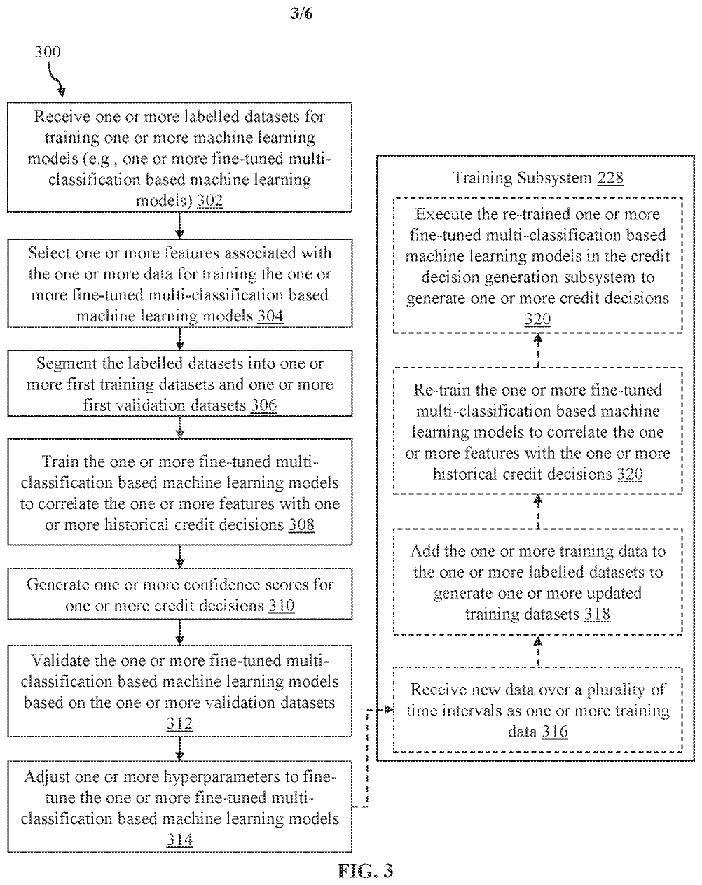

Furthermore, the one or more second users may use a web application through the local browser, the mobile application to communicate with the ML-based computing system 104. In an embodiment of the present disclosure, the ML-based computing system 104 includes a plurality of subsystems 110. Details on the plurality of subsystems 110 have been elaborated in subsequent paragraphs of the present description with reference to FIG. 2.

FIG. 2 is a detailed view of the ML-based computing system 104 for managing the one or more credit risks of the one or more first users, in accordance with another embodiment of the present disclosure. The ML-based computing system 104 includes a memory 202, one or more hardware processors 204, and a storage unit 206. The memory 202, the one or more hardware processors 204, and the storage unit 206 are communicatively coupled through a system bus 208 or any similar mechanism. The memory 202 includes the plurality of subsystems 110 in the form of programmable instructions executable by the one or more hardware processors 204.

The plurality of subsystems 110 includes an input receiving subsystem 210, a data retrieval subsystem 212, a data preprocessing subsystem 214, a credit risk determining subsystem 216, a credit decision generation subsystem 218, a confidence score generation subsystem 220, a credit limit determining subsystem 222, an auto-approval subsystem 224, an output subsystem 226, and a training subsystem 228. The brief details of the plurality of subsystems 110 have been elaborated in a below table.

| Plurality of | |
|---|---|
| Subsystems 110 | Functionality |
| Input receiving | The input receiving subsystem 210 is configured to receive the |
| subsystem 210 | one or more inputs from the one or more electronic devices 102 |
| | associated with the one or more second users. |
| Data retrieval | The data retrieval subsystem 212 is configured to retrieve the |
| subsystem 212 | one or more data associated with the one or more first users |
| | from the one or more databases 108, based on the one or more |
| | inputs received from the one or more electronic devices 102 |
| | associated with the one or more second users. |
| Data | The data preprocessing subsystem 214 is configured to |
| preprocessing | preprocess the one or more data to remove at least one of: the |
| subsystem 214 | one or more noises, the one or more outliers, and the one or |
| | more missing values, from one or more datasets. |
| Credit risk | The credit risk determining subsystem 216 is configured to |
| determining | determine the one or more credit risks of the one or more |
| subsystem 216 | entities associated with the one or more first users based on the |
| | preprocessed one or more data, by the one or more fine-tuned |
| | multi-classification based machine learning models. |
| Credit decision | The credit decision generation subsystem 218 is configured to |
| generation | generate the one or more credit decisions for the one or more |
| subsystem 218 | entities associated with the one or more first users based on the |
| | determined one or more credit risks of the one or more entities |
| | associated with the one or more first users, by the one or more |
| | fine-tuned multi-classification based machine learning models. |
| Confidence | The confidence score generation subsystem 220 is configured |
| score | to generate the one or more confidence scores for each credit |
| generation | decision of the one or more credit decisions to classify the one |
| subsystem 220 | or more credit decisions, based on the correlation between the |
| | one or more data and the one or more credit decisions. |
| Credit limit | The credit limit determining subsystem 222 is configured to |
| determining | determine at least one of: the one or more recommended credit |
| subsystem 222 | values, the one or more recommended first credit limits, and the |
| | one or more recommended second credit limits, based on the |
| | classification of at least one of: the one or more first credit |
| | decisions, the one or more second credit decisions, the one or |
| | more third credit decisions. |
| Auto-approval | The auto-approval subsystem 224 is configured to provide the |
| subsystem 224 | one or more automated approvals for the one or more credit |
| | decisions, based on the one or more second pre-configured |
| | rules and parameters. |
| Output | The output subsystem 226 is configured to provide the output |
| Subsystem 226 | of at least one of: the one or more credit decisions, the one or |
| | more recommended credit values, the one or more |
| | recommended first credit limits, and the one or more |
| | recommended second credit limits, to the one or more second |
| | users on the one or more user interfaces associated with the one |
| | or more electronic devices 102. |
| Training | The training subsystem 228 is configured to re-train the one or |
| subsystem 228 | more fine-tuned multi-classification based machine learning |
| | models over a plurality of time intervals with one or more |
| | training data. |

The one or more hardware processors 204, as used herein, means any type of computational circuit, including, but not limited to, at least one of: a microprocessor unit, microcontroller, complex instruction set computing microprocessor unit, reduced instruction set computing microprocessor unit, very long instruction word microprocessor unit, explicitly parallel instruction computing microprocessor unit, graphics processing unit, digital signal processing unit, or any other type of processing circuit. The one or more hardware processors 204 may also include embedded controllers, including at least one of: generic or programmable logic devices or arrays, application specific integrated circuits, single-chip computers, and the like.

The memory 202 may be non-transitory volatile memory and non-volatile memory. The memory 202 may be coupled for communication with the one or more hardware processors 204, being a computer-readable storage medium. The one or more hardware processors 204 may execute machine-readable instructions and/or source code stored in the memory 202. A variety of machine-readable instructions may be stored in and accessed from the memory 202. The memory 202 may include any suitable elements for storing data and machine-readable instructions, including at least one of: read only memory, random access memory, erasable programmable read only memory, electrically erasable programmable read only memory, a hard drive, a removable media drive for handling compact disks, digital video disks, diskettes, magnetic tape cartridges, memory cards, and the like. In the present embodiment, the memory 202 includes the plurality of subsystems 110 stored in the form of machine-readable instructions on any of the above-mentioned storage media and may be in communication with and executed by the one or more hardware processors 204.

The storage unit 206 may be a cloud storage, a Structured Query Language (SQL) data store, a noSQL database or a location on a file system directly accessible by the plurality of subsystems 110.

The plurality of subsystems 110 includes the input receiving subsystem 210 that is communicatively connected to the one or more hardware processors 204. The input receiving subsystem 210 is configured to receive the one or more inputs from the one or more electronic devices 102 associated with the one or more second users. In an embodiment, the one or more inputs may include the one or more information related to at least one of: the one or more entities associated with the one or more first users whose credit risk is required to be assessed.

The plurality of subsystems 110 further includes the data retrieval subsystem 212 that is communicatively connected to the one or more hardware processors 204. The data retrieval subsystem 212 is configured to retrieve the one or more data associated with the one or more first users from the one or more databases 108, based on the one or more inputs received from the one or more electronic devices 102 associated with the one or more second users. In an embodiment, the one or more data are used for credit risk assessment of the one or more entities associated with the one or more first users. In another embodiment, the one or more data may include at least one of: the one or more credit agency data, the one or more accounts receivables data, the one or more financial metrics, and the one or more entity data (e.g., one or more derived entity data), associated with the one or more first users.

In an embodiment, the one or more credit agency data may include at least one of: one or more agency scores, one or more payment ratings, one or more spend scores, one or more risk of distress scores, default scores, one or more current metrics, one or more provider benchmarking, and the like. The one or more agency scores is configured to serve as a numeric indicator reflecting a company's creditworthiness. In an embodiment, the one or more agency scores are determined from an analysis of financial variables, payment history, and industry benchmarks. Generally, one or more higher agency scores denote lower credit risk, offering valuable insights for businesses and lenders. In a non-limiting example, the one or more agency scores may be provided by one or more third-party agencies.

The one or more payment ratings are configured to analyze a company's payment behavior, providing a gauge of the company's reliability in meeting financial obligations. A favourable payment rating indicates a history of punctual payments, contributing to a positive assessment of the creditworthiness. The one or more spend scores are configured to assess a company's financial management and spending patterns. The one or more spend scores takes into consideration one or more factors including at least one of: adherence to budgets and overall fiscal discipline. In an embodiment, one or more higher spend scores suggest prudent financial practices.

The one or more risk of distress scores are configured to evaluate the likelihood of a company encountering financial distress or bankruptcy. By determining one or more financial indicators, the one or more risk of distress scores are configured to offer a glimpse into the overall financial health and stability of the business. The one or more current metrics may include one or more real-time financial metrics and scores configured to provide an updated snapshot of a company's financial health. The one or more real-time financial metrics and scores may encompass at least one of: current revenue, profit margins, and liquidity ratios, offering a dynamic perspective for assessment. The one or more provider benchmarking are configured to compare a company's performance metrics with industry benchmarks or sector standards. The one or more provider benchmarking are used in understanding how a company compares to its peers, providing valuable context for performance evaluation in a broader business landscape.

In an embodiment, the one or more accounts receivables data may include at least one of: one or more historical invoice data, one or more payment trend data, one or more historical credit limit data, one or more credit exposure data, one or more risk class data, one or more credit utilization percentage data, one or more historical credit utilization percentage data, one or more historical number of days to reach credit limit data, one or more average time to review data, one or more average time to clear blocked order data, one or more aggregated and masked data, and the like.

The one or more historical invoice data may include a detailed record of invoices issued to the one or more first users (e.g., entities or customers) over a specified period. This information is crucial for tracking a billing history and identifying any recurring patterns in entity transactions. The one or more payment trend data are configured to reflect a pattern and consistency of entity payments over time. By analyzing the one or more payment trend data, the one or more second users (e.g., the businesses) may gain insights into the reliability of the entities in meeting their payment obligations. The one or more historical credit limit data are configured to record a credit limit assigned to the entity on a monthly or yearly basis. The one or more historical credit limit data in one or more datasets provides valuable context for understanding how the credit limit has changed over time, aiding in the risk assessment.

The one or more credit exposure data are configured to indicate/represent a total amount of credit that is currently at risk with a particular entity. The one or more credit exposure data are essential for gauging the financial exposure and potential risk associated with each entity. The one or more risk class data are configured to assign a classification or rating to entities based on their creditworthiness and risk level. This categorization/classification helps the businesses make informed the one or more credit decisions and implement appropriate risk management strategies. The one or more credit utilization percentage data are configured to indicate a percentage of the assigned credit limit that an entity is currently using. The one or more credit utilization percentage data are valuable for understanding how much of the available credit an entity is utilizing, impacting their credit risk.

The one or more historical credit utilization percentage data are configured to track the historical trend of how much of the credit limit an entity has utilized over time. The one or more historical credit utilization percentage data are configured to provide context for understanding changes in an entity's credit utilization patterns. The one or more historical number of days to reach credit limit data are configured to indicate/represent a number of days it took for entities to reach their credit limit in the past. Analyzing the one or more historical number of days to reach credit limit data may offer insights into the speed at which the entities exhaust their credit limits, aiding in the risk assessment. The one or more average time to review data are configured to indicate/represent an average time taken to review accounts, categorized by risk class. The one or more average time to review data are crucial for understanding the efficiency of the credit review process for different risk classes.

The one or more average time to clear blocked order data are configured to indicate an average time taken to resolve and clear a blocked order due to credit issues. The one or more average time to clear blocked order data are configured to highlight the effectiveness of the process in addressing and resolving credit-related challenges. The one or more aggregated and masked data across entities are configured to simplify complex patterns, reducing noise and highlighting overall trends within one or more datasets. The one or more aggregated and masked data are further configured to enhance generalization by providing a more robust representation of the underlying patterns in the one or more data.

In an embodiment, the one or more financial metrics may include at least one of; one or more current ratios, one or more quick ratios, one or more debt-to-equity ratios, one or more price-to-earnings ratios, one or more annual growth rates, and the like. The one or more current ratios are liquidity metrics that are configured to evaluate a company's ability to cover its short-term liabilities with its short-term assets. By dividing current assets by current liabilities, the one or more current ratios are configured to provide insights into the company's capacity to meet its immediate financial obligations. One or more higher current ratios are generally interpreted as a positive indicator, indicating/signalling a better ability to handle short-term financial commitments.

The one or more quick ratios known as the liquidity ratios or acid-test ratios, are more stringent measures of liquidity. The one or more quick ratios are configured to assess a company's ability to cover short-term liabilities without relying on the sale of inventory. By excluding inventory from current assets, the one or more quick ratios are configured to offer a conservative view of the company's liquidity. One or more higher quick ratios suggest a more robust ability to meet short-term obligations even in the absence of inventory sales. The one or more debt-to-equity ratios are solvency metrics that are configured to gauge the proportion of a company's financing that comes from debt as opposed to equity. By dividing total debt by shareholders' equity, the one or more debt-to-equity ratios are configured to provide insights into the financial risk associated with a company, one or more higher debt-to-equity ratios may indicate a higher level of financial leverage and potential risk, as a significant portion of funding comes from the debt.

The one or more price-to-earnings ratios are valuation metrics that are configured to compare a company's current stock price to its earnings per share (EPS). One or more investors may utilize the one or more price-to-earnings ratios to assess the market's expectations for a company's future earnings growth. One or more higher price-to-earnings ratios are often interpreted as a sign of higher anticipated earnings growth and can influence investment decisions based on perceived value. The one or more annual growth rates are measures of a specific financial metric's percentage increase over a one-year period. The one or more annual growth rates are configured to evaluate the growth of key indicators including at least one of: revenue or earnings, and a positive growth rate suggesting a healthy and expanding business. Monitoring the one or more annual growth rates provides valuable insights into a company's performance trajectory and potential for sustained success in the market.

In an embodiment, the one or more derived entity data may include at least one of: one or more credit usage percentage changes, one or more credit utilization changes, one or more unutilized credit percentage changes, one or more credit limit median ratios, one or more days since last credit upgrade or extensions, one or more number of days since upgrades, one or more number of days since downgrades, one or more aging buckets, one or more document invoice amounts, one or more global invoice amounts, one or more global predicted amount WADL (weighted average days late), one or more aging bucket ratios, one or more document invoice amount ratios, one or more global invoice amount ratios, one or more document cash collected ratios, one or more document cash collected max ratios, one or more percentage change in unutilized over downgrades, one or more risk classes, and the like.

The one or more credit usage percentage changes are configured to measure changes in the percentage of credit utilized. The one or more credit usage percentage changes are configured to determine a percentage change between the immediate last two values of the percentage of credit utilized by the one or more first users (e.g., borrowers). For instance, if the percentage of credit utilized by the borrowers was 40% last month and 45% this month, the simple percentage change would be (45−40)/40=12.5%. The one or more credit utilization changes are configured to measure a change in an actual amount of credit utilized. The one or more credit utilization changes are configured to determine the percentage change between the immediate last two values of the total credit utilized. For example, if $50,000 was utilized last month and $60,000 this month, the simple percentage change would be (60,000−50,000)/50,000=20%.

The one or more unutilized credit percentage changes are configured to measure a percentage change in the amount of credit that remains unutilized or unused. The one or more unutilized credit percentage changes are configured to determine the difference between the immediate last two values of unutilized credit and expresses this change as a percentage. For example, if there was $10,000 unutilized credit last month and $8,000 unutilized credit this month, the simple percentage change would be calculated as (8,000−10,000)/10,000=−0.2, or a decrease of 20%. The one or more credit limit median ratios are configured to measure an entity's credit limit relative to the median credit limit of all entities across accounts at a specific point in time. The one or more credit limit median ratios are determined by dividing an individual entity's credit limit by the median credit limit of all entities. For example, if an entity has a credit limit of $20,000 and the median credit limit across all entities is $15,000, the ratio would be 20,000/15,000=1.33.

The one or more days since last credit upgrade or extensions are configured to measure a duration in days since a specific action, either a credit upgrade or a credit extension was last performed for a particular entity. For example, if an entity received an upgrade or an extension of their service or credit account 30 days ago, the value for this feature would be 30. The one or more number of days since upgrades are configured to measure a duration in days since a specific credit upgrade action was last implemented for a particular entity. For example, if an entity's credit was upgraded 30 days ago, the value for this feature would be 30. The one or more number of days since downgrades are configured to measure a duration in days since a specific credit downgrade action was last implemented for a particular entity. For example, if an entity's credit was downgraded 15 days ago, the value for this feature would be 15.

The one or more aging buckets refer to the categorization or classification of delinquent accounts based on a duration for which a payment remains overdue. The one or more aging buckets are segments or categories that group accounts based on the number of days past due. For example, a first bucket (e.g., bucket 1) may represent accounts with payments overdue for 1-30 days. A second bucket (e.g., bucket 2) may represent accounts with payments overdue for 31-60 days. A third bucket (e.g., bucket 3) may represent accounts with payments overdue for 61-90 days. The one or more document invoice amounts refer to an aggregate of a total invoiced amount for an entity, aiding in financial analysis by considering the entity's invoicing behavior and its influence on their credit risk. In a non-limiting example, if a first entity (e.g., customer A) consistently maintains a high aggregate invoice amount, the one or more document invoice amounts may indicate a strong and reliable payment history, suggesting lower credit risk. On the contrary, if a second entity (e.g., customer B) exhibits erratic invoice amounts or consistently delays payments, the one or more document invoice amounts could raise concerns about their creditworthiness.

The one or more global invoice amounts refer to a comprehensive view of an entity's invoiced amounts in a context of an entire entity base. Understanding an entity's invoicing behavior relative to the broader set of entities may offer insights into their credit risk level. The one or more global predicted amount WADL (weighted average days late) refer to an aggregate of the predicted amounts based on the weighted average days late for an entity, aiding in assessing their credit risk through predictive analytics related to potential payment delays. The one or more aging bucket ratios are configured to normalize an entity's aging bucket in comparison to a mean aging bucket across all entities. The one or more aging bucket ratios are configured to provide insights into an entity's account inactivity relative to the average, impacting their credit risk evaluation.

In a non-limiting example, if Customer A has an aging bucket ratio of 0.8, the one or more aging bucket ratios suggest that their account has been inactive for a period 20% less than the average across all entities. One or more higher aging bucket ratios may indicate that an entity is more actively using their account than the average, potentially indicating/signalling lower credit risk. Conversely, a lower ratio may suggest increased account inactivity, prompting an institution to consider potential credit risk implications and adjust their evaluation accordingly.

The one or more document invoice amount ratios are configured to normalize an entity's invoiced amount concerning a mean invoiced amount across all entities, providing insights into their invoicing behavior relative to the average and its influence on their credit risk. The one or more global invoice amount ratios are configured to offer a normalized view of an entity's global invoicing behavior in relation to the mean global invoicing behavior across all entities. This comparison aids in assessing an entity's credit risk level. The one or more document cash collected ratios are configured to evaluate an entity's cash collection efficiency concerning the average invoiced amounts. The one or more document cash collected ratios may indicate how effectively an entity collects cash concerning their invoiced amounts, influencing their credit risk assessment.

The one or more document cash collected max ratios are configured to normalize an entity's cash collection efficiency by comparing the entity's cash collection efficiency to maximum invoiced amounts among the latest entities. This comparison offers insights into the entity's efficiency in cash collection in the context of recent high invoiced amounts. The one or more percentage change in unutilized over downgrades are configured to analyze the percentage change in an entity's unutilized resources compared to the average change during downgrade actions. This comparison provides insights into how an entity's unutilized resources behave concerning the typical change during downgrade events, impacting their credit risk assessment. The one or more risk classes are configured to map an entity to a risk class, providing a categorical representation of their risk level. This classification aids in risk management and helps in identifying and managing entities with different credit risk profiles.

The plurality of subsystems 110 includes the data preprocessing subsystem 214 that is communicatively connected to the one or more hardware processors 204. The data preprocessing subsystem 214 is configured to preprocess the one or more data to remove at least one of: the one or more noises, the one or more outliers, and the one or more missing values, from the one or more datasets comprising the one or more data. Further, the one or more data are preprocessed to at least one of: normalize and standardize the one or more data to be consistent and compatible based on one or more first pre-configured rules and parameters.

In an embodiment, the data preprocessing subsystem 214 is configured to remove entries with null values in required columns. For example, if the one or more datasets include a column for “Historical Invoice data” and some entries have missing values in this column, those rows are removed to ensure that age information is available for all analyzed records. In another embodiment, the data preprocessing subsystem 214 is further configured to filter active credit entities. For example, in the one or more datasets, only entities with an “Active” status are considered for analysis, filtering out those who have closed their accounts or are no longer active.

In yet another embodiment, the data preprocessing subsystem 214 is further configured to handle credit changes with missing values. In the one or more datasets, credit changes entries with missing old values or missing new values are removed, ensuring data integrity. In yet another embodiment, the data preprocessing subsystem 214 is further configured to remove first reviews of entities. In yet another embodiment, the data preprocessing subsystem 214 is further configured to handle the one or more outliers in the credit limit changes. The credit limit changes below a specified threshold are considered outliers and removed. For example, the credit limit changes resulting in a limit below $1,000 are excluded.

In yet another embodiment, the data preprocessing subsystem 214 is further configured to select unique entities for modeling. In yet another embodiment, the data preprocessing subsystem 214 is further configured such that multiple credit changes on a single day are consolidated to the first and final changes. In yet another embodiment, the data preprocessing subsystem 214 is further configured such that all currencies in the one or more datasets are converted to a single currency for consistency.

The plurality of subsystems 110 includes the credit risk determining subsystem 216 that is communicatively connected to the one or more hardware processors 204. The credit risk determining subsystem 216 is configured to determine the one or more credit risks of the one or more entities associated with the one or more first users based on the preprocessed one or more data, by the one or more fine-tuned multi-classification based machine learning models.

The plurality of subsystems 110 includes the credit decision generation subsystem 218 that is communicatively connected to the one or more hardware processors 204. The credit decision generation subsystem 218 is configured to generate the one or more credit decisions for the one or more entities associated with the one or more first users based on the determined one or more credit risks of the one or more entities associated with the one or more first users, by the one or more fine-tuned multi-classification based machine learning models.

The plurality of subsystems 110 includes the confidence score generation subsystem 220 that is communicatively connected to the one or more hardware processors 204. The confidence score generation subsystem 220 is configured to generate the one or more confidence scores for each credit decision of the one or more credit decisions to classify the one or more credit decisions, based on the correlation between the one or more data and the one or more credit decisions. A higher confidence score may suggest that the ML-based computing system 104 is more certain about its recommendation, while a lower score may indicate a higher degree of uncertainty. In an embodiment, the classification of the one or more credit decisions may include at least one of: the one or more first credit decisions (e.g., the one or more credit upgrade decisions), the one or more second credit decisions (e.g., the one or more credit downgrade decisions), and the one or more third credit decisions (e.g., the one or more credit extension decisions).

In an embodiment, the credit risk determining subsystem 216, the credit decision generation subsystem 218, and the confidence score generation subsystem 220, may utilize the one or more fine-tuned multi-classification based machine learning models. In an embodiment, the one or more fine-tuned multi-classification based machine learning models are trained by correlating the one or more data (e.g., entity data) with the one or more credit decisions. In an embodiment, the one or more fine-tuned multi-classification based machine learning models may include at least one of: a random forest model, an extreme gradient boosting (XGBoost) classifier model, a K-means clustering model, a light gradient-boosting machine (LightGBM) classifier model. In an embodiment, the one or more data received from the data preprocessing system 214 are used to dynamically determine the one or more credit risks of the one or more entities, to generate the one or more credit decisions, and to generate the one or more confidence scores for the one or more credit decisions, based on a pre-trained one or more fine-tuned multi-classification based machine learning models.

In one embodiment, for generating the one or more credit decisions for the one or more entities and the one or more confidence scores for the one or more credit decisions, the random forest model is used. The random forest model is configured to correlate the one or more entity data received from the data preprocessing subsystem 214 with the one or more credit decisions. Based on prior training, the random forest model is further configured to generate the one or more confidence scores on each credit decision. In one embodiment, the random forest model is configured to leverage a concept of ensemble learning, where multiple decision trees work collaboratively to enhance predictive accuracy and mitigate the risk of overfitting. Each decision tree in the ensemble contributes to the final credit decision, and their combined output results in a more stable and accurate assessment.

In another embodiment, based on prior training, the random forest model is configured to generate the one or more credit decisions. The training involves exposing the random forest model to a diverse set of historical entity data, allowing the random forest model to learn and adapt to various scenarios. The trained random forest model is then applied to make informed one or more credit decisions in real-time. In another embodiment, the random forest model goes a step further by generating the one or more confidence scores for each credit decision. The one or more confidence scores provides valuable insights into the model's level of certainty, allowing for more nuanced credit decision interpretation. The one or more confidence scores are crucial elements in risk management and aids in distinguishing between highly certain and more tentative credit decisions.

In another embodiment, for generating the one or more credit decisions for the one or more entities and the one or more confidence scores for the one or more credit decisions, the extreme gradient boosting (XGBoost) classifier model is used. The XGBoost Classifier model is configured to correlate the one or more entity data received from the data preprocessing subsystem 214 with the one or more credit decisions. Based on prior training, the XGBoost Classifier model is further configured to generate one or more confidence scores on each credit decision. In one embodiment, the XGBoost Classifier employs an ensemble learning approach, using shallow decision trees as base learners. Through boosting, the XGBoost Classifier model sequentially builds trees, with each subsequent tree correcting errors from its predecessors, thereby enhancing the overall model accuracy. The optimization process involves minimizing a user-specified objective function, often the logistic loss for binary classification. A gradient descent is employed to iteratively update model parameters in the direction that minimizes the loss.

In another embodiment, to prevent overfitting, the XGBoost Classifier model incorporates regularization terms, offering support for both L1 (Lasso) and L2 (Ridge) regularization methods. The depth of trees is controlled to avoid overcomplexity, and pruning techniques remove branches that do not significantly contribute to performance improvement. The XGBoost Classifier model is further configured to assess feature importance by determining the gain achieved through each feature's split. This feature importance analysis enables efficient feature selection, promoting model interpretability and efficiency.

In another embodiment, a distinctive feature of the XGBoost Classifier model is its ability to handle the missing values in the input data. Furthermore, the XGBoost Classifier model is designed for efficient parallel and distributed computing, leveraging multiple CPU cores and enabling scalability for large datasets. In one embodiment, the XGBoost Classifier model is trained on historical data to learn correlations between the one or more entity data and the one or more credit decisions. The XGBoost Classifier model is configured to generate confidence scores for its predictions, with higher scores indicating greater certainty in the one or more credit decisions.

In yet another embodiment, for generating the one or more credit decisions for the one or more entities and the one or more confidence scores for the one or more credit decisions, the K-means clustering model is used. The K-means clustering model is configured to correlate the one or more entity data received from the data preprocessing subsystem 214 with the one or more credit decisions. Based on prior training, the K-means clustering model is further configured to generate the one or more confidence scores on each credit decision. In an embodiment, the primary goal of the K-means clustering model is to correlate the one or more entity data with the one or more credit decisions and to generate the one or more confidence scores for each decision. Under supervision, the K-means clustering model undergoes a training phase where the K-means clustering model learns patterns in the one or more data (e.g., the one or more entity data). During training, the K-means clustering model is configured to identify one or more clusters of similar data points based on input entity data and associates the one or more clusters with the one or more credit decisions.

In an embodiment, one or more features used for clustering may include one or more aspects of the one or more entity data as received from the data preprocessing subsystem 214. In another embodiment, the K-means clustering model is employed to partition the one or more datasets into “K” clusters. The value of “K” is determined based on one or more characteristics of the one or more data and the desired granularity of clustering. Each cluster is associated with a certain credit decision. This implies that the one or more entities falling into the same cluster are likely to receive similar credit decisions. In another embodiment, the K-means clustering model is further configured to generate the one or more confidence scores for each decision. The one or more confidence scores reflects the model's certainty or confidence in the assigned credit decision for a given entity. In certain embodiments, the K-means clustering model is configured for real-time correlation. When a new set of entity data is received, the K-means clustering model is configured to utilize the learned clusters to quickly associate the one or more data with a particular credit decision and assigns the one or more confidence scores.

In yet another embodiment, for generating the one or more credit decisions for the one or more entities and the one or more confidence scores for the one or more credit decisions, the light gradient-boosting machine (LightGBM) classifier model is used. The LightGBM classifier model is configured to correlate the one or more entity data received from the data preprocessing subsystem 214 with the one or more credit decisions. Based on prior training, the LightGBM classifier model is further configured to generate the one or more confidence scores on each credit decision.

In one embodiment, before generating the one or more credit decisions, the LightGBM classifier model undergoes a training phase. During this training phase, the historical data containing both input features (e.g., the one or more entity data) and corresponding one or more credit decisions are used to teach the LightGBM classifier model how to correlate the input features with the desired output. In another embodiment, the LightGBM classifier model is an ensemble learning method that builds a series of decision trees to make predictions. Decision trees are constructed recursively by selecting the best split points based on certain criteria (e.g., Gini impurity or information gain). In yet another embodiment, the LightGBM classifier model uses a gradient boosting framework, where each tree corrects errors made by the previous ones. This iterative process leads to a strong predictive model. In yet another embodiment, the trained LightGBM classifier model learns to correlate specific patterns in the one or more entity data with the one or more credit decisions. The LightGBM classifier model identifies which features are most important for making accurate predictions.

In another embodiment, in addition to predicting the one or more credit decisions, the LightGBM classifier model is configured to generate the one or more confidence scores for each decision. The one or more confidence scores reflect the model's level of certainty in its prediction. In certain embodiments, the performance of the LightGBM classifier model is influenced by one or more hyperparameters, which are configuration settings that control the training process. The one or more hyperparameters may be tuned to optimize the model's accuracy and efficiency. In yet another embodiment, the LightGBM classifier model is designed to be efficient and scalable, making it suitable for large datasets. The LightGBM classifier model can handle a substantial amount of the one or more entity data for training and making predictions.

The plurality of subsystems 110 includes the credit limit determining subsystem 222 that is communicatively connected to the one or more hardware processors 204. The credit limit determining subsystem 222 is configured to dynamically determine at least one of; the one or more recommended credit values, the one or more recommended first credit limits (e.g., the one or more recommended upper credit limits), and the one or more recommended second credit limits (e.g., the one or more recommended lower credit limits), based on the classification of at least one of: the one or more first credit decisions (e.g., the one or more credit upgrade decisions), the one or more second credit decisions (e.g., the one or more credit downgrade decisions), the one or more third credit decisions (e.g., the one or more credit extension decisions).

In an embodiment, the credit limit determining subsystem 222 is further configured to retrieve the one or more current credit limits and to maintain the one or more current credit limits, for the one or more entities associated with the one or more first users when the one or more third credit decisions are generated. In another embodiment, the credit limit determining subsystem 222 is further configured to determine at least one of: the one or more recommended first credit limits, and the one or more recommended second credit limits, upon generation of at least one of: the one or more first credit decisions and the one or more second credit decisions, based on one or more key statistical parameters.

In an embodiment, the one or more key statistical parameters may include at least one of: the one or more current credit limits (e.g., old credit limits), median, and standard deviation. In an embodiment, the one or more current credit limits (e.g., old credit limits) act as one or more reference points when the median and the standard deviation provide one or more insights into a central tendency and variability of the one or more data.

In an embodiment, the one or more recommended credit values are determined by adding one or more scaled values of the standard deviation to the one or more current credit limits, with one or more first scaling factors associated with one or more first configurable statistical variables (“x”), when the one or more first credit decisions (e.g., the one or more credit upgrade decisions) are generated. The one or more recommended first credit limits (e.g., the one or more recommended upper credit limits) are determined by adding the one or more scaled values of the standard deviation to the one or more current credit limits, with one or more second scaling factors associated with one or more second configurable statistical variables (“y”), when the one or more first credit decisions (e.g., the one or more credit upgrade decisions) are generated. The one or more recommended third credit limits (e.g., the one or more recommended lower credit limits) are determined by at least one of: adding the one or more scaled values of the standard deviation to the one or more current credit limits, with one or more third scaling factors associated with one or more third configurable statistical variables (“z”), when the one or more first credit decisions (e.g., the one or more credit upgrade decisions) are generated.

In a non-limiting embodiment, one or more equations for the recommended credit limit in one or more credit upgrade decisions are as follows.

$$Eqn ( 1 )$$

$$Recommended value = old limit + ( median + x * ( standard deviation ) )$$

$$Eqn ( 2 )$$

$$Recommended upper limit = old limit + ( median + y * ( standard deviation ) )$$

$$Eqn ( 3 )$$

$$Recommended lower limit = old limit + ( median + z * ( standard deviation ) )$$

In another embodiment, the one or more recommended credit values are determined by subtracting the one or more scaled values of the standard deviation to the one or more current credit limits, with the one or more first scaling factors associated with the one or more first configurable statistical variables (“x”), when the one or more second credit decisions (e.g., the one or more credit downgrade decisions) are generated. The one or more recommended first credit limits (e.g., the one or more recommended upper credit limits) are determined by subtracting the one or more scaled values of the standard deviation to the one or more current credit limits, with the one or more second scaling factors associated with the one or more second configurable statistical variables (“y”), when the one or more second credit decisions (e.g., the one or more credit downgrade decisions) are generated. The one or more recommended third credit limits (e.g., the one or more recommended lower credit limits) are determined by at least one of: subtracting the one or more scaled values of the standard deviation to the one or more current credit limits, with the one or more third scaling factors associated with the one or more third configurable statistical variables (“z”), when the one or more second credit decisions (e.g., the one or more credit downgrade decisions) are generated.

In a non-limiting embodiment, one or more equations for the recommended credit limit in one or more credit downgrade decision are as follows.

$$Eqn ( 4 )$$

$$Recommended value = old limit - ( median + x * ( standard deviation ) )$$

$$Eqn ( 5 )$$

$$Recommended upper limit = old limit - ( median + y * ( standard deviation ) )$$

$$Eqn ( 6 )$$

$$Recommended lower limit = old limit - ( median + z * ( standard deviation ) )$$

The plurality of subsystems 110 includes the auto-approval subsystem 224 that is communicatively connected to the one or more hardware processors 204. The auto-approval subsystem 224 is configured to provide the one or more automated approvals for the one or more credit decisions, based on one or more second pre-configured rules and parameters. In one embodiment, the auto-approval subsystem 224 is configured to obtain the one or more credit decisions from the credit decision generation subsystem 218, the one or more confidence scores from the confidence score generation subsystem 220, and the one or more credit limits generated from the credit limit determining subsystem 222, as inputs. Based on the inputs and pre-configured parameters, the auto-approval subsystem 224 can automatically approve the one or more credit decisions.

In a non-limiting example, the pre-configured parameters may specify that a credit upgrade decision upto USD 100,000 may be automatically approved for an Entity A if the confidence score is greater than 0.9. In another embodiment, the pre-configured parameters may specify that for a credit limit up to USD 1,000.000 may require a manual approval even if the confidence score is greater than 0.9 for the Entity A.

The plurality of subsystems 110 includes a manual review subsystem (not shown in FIG. 2) that is communicatively connected to the one or more hardware processors 204. The manual review subsystem is configured to address and manage scenarios that may require a manual intervention of the one or more second users (e.g., the one or more credit analysts). In certain embodiments, the auto-approval subsystem 224 may not approve the credit limit automatically, and may require the manual intervention of a user based such as the one or more credit analysts or the one or more financial analysts based on the pre-configured parameters.

In one example, the confidence score generation subsystem 220 may generate a confidence score for the credit approval process. If the confidence score falls below a certain threshold, the auto-approval subsystem 224 may flag a particular credit review for a manual review in the manual review subsystem. A lower confidence score could indicate that the ML-based computing system 104 is not sufficiently confident in its ability to assess the creditworthiness of an applicant. In another example, the requested credit limit may be very high. In such a scenario, the auto-approval subsystem 224 may flag the particular credit review for the manual review in the manual review subsystem. This might be a risk management strategy to ensure that large credit limits are carefully evaluated by human analysts to mitigate potential risks.

The plurality of subsystems 110 includes the output subsystem 226 that is communicatively connected to the one or more hardware processors 204. The output subsystem 226 is configured to provide the output of the credit risk assessment to the one or more second users on the one or more user interfaces associated with the one or more electronic devices 102. In other words, the output subsystem 226 is configured to provide the output of at least one of: the one or more credit decisions, the one or more recommended credit values, the one or more recommended first credit limits, and the one or more recommended second credit limits, to the one or more second users on the one or more user interfaces associated with the one or more electronic devices 102.

The plurality of subsystems 110 includes the training subsystem 228 that is communicatively connected to the one or more hardware processors 204. The training subsystem 228 is configured to train the one or more fine-tuned multi-classification based machine learning models. For training the one or more fine-tuned multi-classification based machine learning models, the training subsystem 228 is initially configured to obtain one or more labelled datasets from the one or more databases 108. The one or more labelled datasets may include the one or more data associated with the one or more entities.

The training subsystem 228 is further configured to select one or more features associated with the one or more data for training the one or more fine-tuned multi-classification based machine learning models based on one or more feature engineering processes. In an embodiment, the one or more feature engineering processes involves creation of meaningful and informative input variables based on the one or more entity data that can be used to train the one or more fine-tuned multi-classification based machine learning models. In an embodiment, the one or more feature engineering processes may include at least one of: a forward feature selection process, a backward feature selection process, an exhaustive feature selection process, a recursive feature elimination process, a random forest importance process, a boosted feature extractor process, and the like. The training subsystem 228 is further configured to segment the one or more labelled datasets into at least one of: one or more training datasets and one or more validation datasets.

The training subsystem 228 is further configured to train the one or more fine-tuned multi-classification based machine learning models to correlate the one or more features associated with the one or more data, with one or more historical credit decisions. The one or more historical credit decisions may include at least one of: one or more first historical credit decision, one or more second historical credit decisions, one or more third historical credit decisions. The training subsystem 228 is further configured to generate the one or more confidence scores for each credit decision of the one or more credit decisions, based on the trained one or more fine-tuned multi-classification based machine learning models.

The training subsystem 228 is further configured to validate the one or more fine-tuned multi-classification based machine learning models based on the one or more validation datasets by determining whether one or more metric scores attained by the trained machine learning model, exceeds one or more pre-determined threshold values. In an embodiment, the one or more metric scores are associated with one or more validation metrics including at least one of; precision metric, recall metric, F1-score metric, and the like. The training subsystem 228 is further configured to adjust one or more hyperparameters to fine-tune the one or more fine-tuned multi-classification based machine learning models based on one or more results of validation of the one or more fine-tuned multi-classification based machine learning models.

In an embodiment, the training subsystem 228 is configured to re-train the one or more fine-tuned multi-classification based machine learning models over a plurality of time intervals based on one or more training data. For re-training the one or more fine-tuned multi-classification based machine learning models, the training subsystem 228 is initially configured to receive the one or more training data corresponding to the one or more data associated with the one or more second users over the plurality of time intervals. The training subsystem 228 is further configured to add the one or more training data with the one or more labelled datasets to generate one or more updated training datasets. The one or more updated training datasets may include both the old and new data points.

The training subsystem 228 is further configured to re-train the one or more fine-tuned multi-classification based machine learning models to correlate the one or more features associated with the one or more data, with the one or more historical credit decisions. In an embodiment, the re-training process for the one or more fine-tuned multi-classification based machine learning models includes continuous evaluation and tuning to assess the quality of the mappings and iteratively improving the results if necessary. The steps are repeated for a fixed number of iterations until the ML-based computing system 104 generates the one or more credit decisions for one or more new entities with sufficient accuracy. The training subsystem 228 is further configured to execute the re-trained one or more fine-tuned multi-classification based machine learning models in the credit decision generation subsystem 218 to generate the one or more credit decisions for the one or more entities associated with the one or more first users.

FIG. 3 is a process flow 300 of training the one or more fine-tuned multi-classification based machine learning models for managing the one or more credit risks of the one or more first users, in accordance with an embodiment of the present disclosure. At step 302, the one or more labelled datasets are obtained for training the one or more fine-tuned multi-classification based machine learning models. In an embodiment, the one or more labelled datasets may include the one or more data associated with the one or more entities.

At step 304, the one or more features associated with the one or more data are selected for training the one or more fine-tuned multi-classification based machine learning models based on the one or more feature engineering processes. In an embodiment, the one or more feature engineering processes may include at least one of: the forward feature selection process, the backward feature selection process, the exhaustive feature selection process, the recursive feature elimination process, the random forest importance process, the boosted feature extractor process, and the like.

The forward feature selection process is configured to build the one or more fine-tuned multi-classification based machine learning models by iteratively adding one data point at a time to the existing set of features. The forward feature selection process begins with an empty set and evaluates an impact of adding each feature individually. The feature that contributes the most to the model's performance is selected and added to the set. The forward feature selection process continues until a predefined criterion, such as a specific number of features or a performance threshold, is met. In another embodiment, the backward feature selection process starts with the complete set of features and eliminates one feature at a time in each iteration. Features are removed based on their impact on the model's performance, typically assessed through a performance metric or a statistical test. The backward feature selection process continues until the desired subset of features is achieved.

The exhaustive feature selection process is configured to evaluate all possible feature combinations to identify a subset that optimally contributes to the model's performance. The recursive feature elimination process is an iterative process that is configured to train the one or more fine-tuned multi-classification based machine learning models and eliminating the least important features in each iteration. The one or more fine-tuned multi-classification based machine learning models are retrained on the reduced feature set until the desired number of features is reached. The recursive feature elimination process is commonly used with the one or more fine-tuned multi-classification based machine learning models that provide feature importance scores, such as support vector machines.

The random forest importance process is a feature selection method based on ensemble learning. In the random forest model, each feature's importance is evaluated based on its contribution to the overall model performance. Features with higher importance scores are considered more influential. The boosted feature extractor process is configured to utilize one or more boosting algorithms including AdaBoost or Gradient Boosting, to iteratively build the one or more fine-tuned multi-classification based machine learning models by assigning different weights to features based on their performance in previous iterations. Features that contribute more to reducing errors are assigned higher weights. The boosted feature extractor process continues until a predefined number of models are combined to create the final ensemble. In certain embodiments, the feature selection step may combine one or more different feature selection steps.

At step 306, the one or more labelled datasets or feature sets are segmented/split into at least one of: the one or more training datasets and the one or more validation datasets. In a non-limiting embodiment, a 70/30 split is used for the one or more training datasets and the one or more validation datasets, respectively. In another non-limiting embodiment, a 80/20 split is used for the one or more training datasets and the one or more validation datasets, respectively.

At step 308, the one or more fine-tuned multi-classification based machine learning models are trained to correlate the one or more features associated with the one or more data, with one or more historical credit decisions. At step 310, the one or more confidence scores are generated for the one or more credit decisions, based on the trained one or more fine-tuned multi-classification based machine learning models. The one or more confidence scores associated with each credit decision indicates the level of certainty or reliability that the one or more fine-tuned multi-classification based machine learning models have in its prediction. A higher confidence score suggests that the ML-based computing system 104 is more certain about its recommendation, while a lower score indicates a higher degree of uncertainty.

At step 312, the one or more fine-tuned multi-classification based machine learning models are validated based on the one or more validation datasets. In an embodiment, the one or more fine-tuned multi-classification based machine learning models are validated by determining whether the one or more metric scores attained by the trained one or more fine-tuned multi-classification based machine learning models, exceeds the one or more predetermined threshold values. In an embodiment, the one or more metric scores are associated with one or more validation metrics including at least one of: the precision metric, the recall metric, the F1-score metric, and the like.

In one embodiment, the precision metric is a metric that reflects an accuracy of positive predictions made by the one or more fine-tuned multi-classification based machine learning models. The precision metric is determined as the ratio of true positive predictions to the total number of positive predictions (true positives plus false positives). In another embodiment, the recall metric, also known as sensitivity or true positive rate, measures the ability of the one or more fine-tuned multi-classification based machine learning models to capture and correctly identify all the relevant instances of a class. The recall metric is determined as the ratio of true positive predictions to the total number of actual positive instances (true positives plus false negatives). In yet another embodiment, the F1-score metric is a balanced metric that combines both precision and recall into a single value. The F1-score metric is determined as the harmonic mean of the precision metric and the recall metric. The harmonic mean provides more weight to lower values, making the F1-score metric sensitive to imbalances between the precision metric and the recall metric.

At step 314, the one or more hyperparameters are adjusted to fine-tune the one or more fine-tuned multi-classification based machine learning models based on the one or more results of validation of the one or more fine-tuned multi-classification based machine learning models. In one embodiment, the one or more hyperparameters are tuned for the random forest model to increase the accuracy of the one or more credit decisions. In one embodiment, the one or more hyperparameters of the random forest model may include at least one of: n_estimators indicating a number of trees in the forest, max_features indicating a maximum number of features considered for splitting a node, max_depth indicating a maximum depth of the trees in the forest, min_samples_split indicating a minimum number of samples required to split an internal node, min_samples_leaf indicating a minimum number of samples required to be at a leaf node, bootstrap indicating whether to use bootstrapped samples when building trees, and criterion indicating function used to measure the quality of a split.

In one embodiment, the one or more hyperparameters are tuned for the XGBoost classifier model to increase the accuracy of the one or more credit decisions. In one embodiment, the one or more hyperparameters of the XGBoost classifier model may include at least one of: learning_rate indicating controls of the contribution of each tree to the final prediction, n_estimators indicating a number of boosting rounds or trees to build, max_depth indicating a maximum depth of a tree, min_child_weight indicating a minimum sum of instance weight needed in a child, subsample indicating a fraction of samples used for training each tree, colsample_bytree indicating a fraction of features used for training each tree, gamma indicating a minimum loss reduction required to make a further partition on a leaf node, lambda indicating a L2 regularization term on weights, alpha indicating a L1 regularization term on weights, objective indicating a learning task and a corresponding objective function), eval_metric indicating an evaluation metric used for early stopping, early_stopping_rounds activating early stopping and the model will stop training if the performance doesn't improve for a specified number of rounds.

In one embodiment, the one or more hyperparameters are tuned for the K-means clustering model to increase the accuracy of the one or more credit decisions. In one embodiment, the one or more hyperparameters of the K-means clustering model may include at least one of a number of clusters indicating “k” representing the desired number of clusters in the data, initialization method determining how the initial centroids for clusters are selected, a maximum number of iterations indicating a maximum number of iterations the algorithm should run to converge to a solution, tolerance indicating a stopping criterion that defines the minimum improvement required to continue the iterations, distance metric indicating a metric used to measure the distance between data points and cluster centroids, random seed indicating a seed value for the random number generator, ensuring reproducibility of results, parallelization indicating controls of the number of parallel jobs.

In one embodiment, the one or more hyperparameters are tuned for the LightGBM model to increase the accuracy of the one or more credit decisions. In one embodiment, the one or more hyperparameters of the LightGBM model may include at least one of: num_leaves indicating a maximum number of leaves in one tree, learning_rate indicating a step size shrinkage to prevent overfitting, n_estimators indicating a number of boosting rounds or trees to build, subsample indicating proportion of data used for each boosting round, colsample_bytree indicating a fraction of features used for each boosting round, min_child_samples indicating a minimum number of data needed in a leaf, reg_alpha indicating the L1 regularization term on weights, reg_lambda indicating the L2 regularization term on weights, max_depth indicating a maximum depth of a tree, min_child_weight indicating a minimum sum of instance weight (hessian) needed in a child, and feature_fraction indicating a fraction of features to be randomly sampled for each boosting round.

In one embodiment, the tuning of the one or more hyper-parameters is performed using at least one process selected from: RandomizedSearchCV, GridSearchCV and Optuna. In one embodiment, RandomizedSearchCV is a hyperparameter tuning technique in which a predefined number of hyperparameter combinations are randomly sampled from the specified search space. These combinations are then used to train and evaluate the one or more fine-tuned multi-classification based machine learning models. In another embodiment, the GridSearchCV is a technique for hyperparameter tuning that performs an exhaustive search over a manually specified subset of the hyperparameter space. The GridSearchCV process is configured to systematically evaluate all possible combinations of hyperparameter values from the provided grid or search space. Each combination is used to train and evaluate the one or more fine-tuned multi-classification based machine learning models using cross-validation. In yet another embodiment, the Optuna is an open-source hyperparameter optimization framework that utilizes a sequential model-based optimization (SMBO) strategy. The Optuna models the relationship between hyperparameter choices and the objective function's performance using Bayesian optimization techniques. The Optuna process is configured to iteratively explore the hyperparameter space based on the results of previous trials to efficiently converge towards optimal values.

At step 316, the one or more training data corresponding to the one or more data associated with the one or more second users are received over the plurality of time intervals. At step 318, the one or more training data are added with the one or more labelled datasets to generate one or more updated training datasets. At step 320, the one or more fine-tuned multi-classification based machine learning models are re-trained to correlate the one or more features associated with the one or more data, with the one or more historical credit decisions. At step 322, the re-trained one or more fine-tuned multi-classification based machine learning models are executed in the credit decision generation subsystem 218 to generate the one or more credit decisions for the one or more entities associated with the one or more first users.

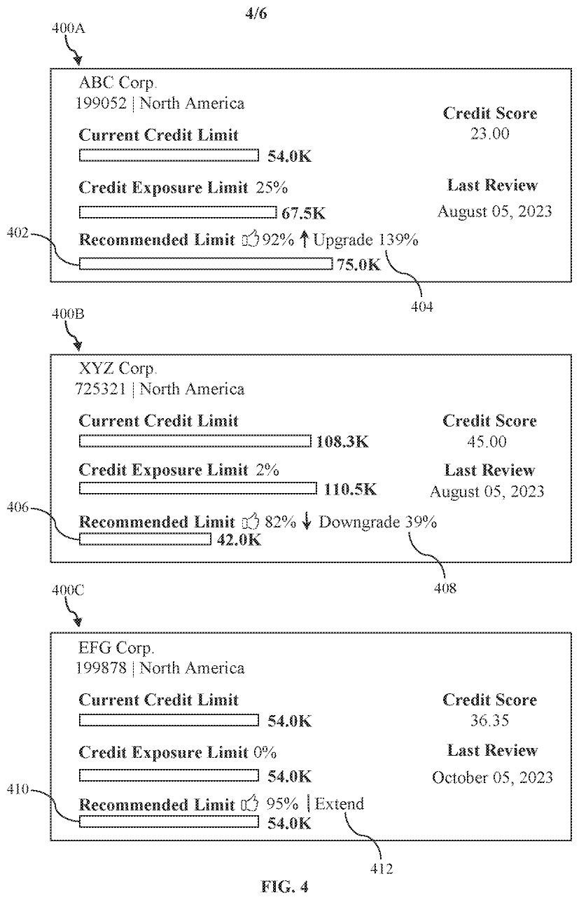

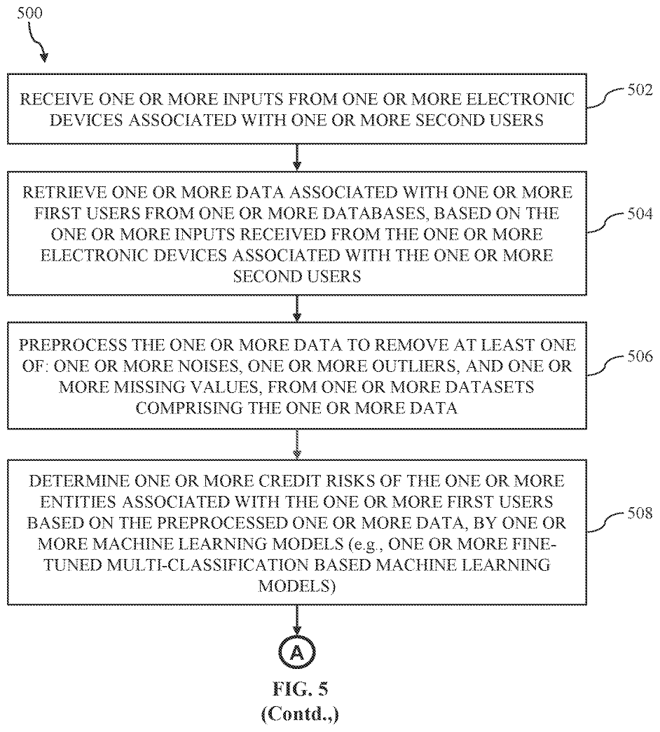

FIG. 4 are exemplary graphical representations (400A-C) depicting an output of at least one of: the one or more credit decisions on one or more user interfaces associated with the one or more electronic devices 102, in accordance with an embodiment of the present disclosure. The graphical representation 400A depicts an output of a credit upgrade decision 404 with a recommended upper credit limit 402 based on at least one of: current credit limit and credit exposure limit. The graphical representation 400B depicts an output of a credit downgrade decision 408 with a recommended lower credit limit 406 based on at least one of: current credit limit and credit exposure limit. The graphical representation 400C depicts an output of a credit extension decision 412 with the recommended extend credit limit 410 based on at least one of; current credit limit and credit exposure limit. In an embodiment, the outputs of the one or more credit decisions (e.g., the credit upgrade decision 404, the credit downgrade decision 408, and the credit extension decision 412) with the one or more recommended credit limits (e.g., the recommended upper credit limit 402, the recommended lower credit limit 406, and the recommended extend credit limit 410), are provided to the one or more second users on the one or more user interfaces associated with the one or more electronic devices 102.

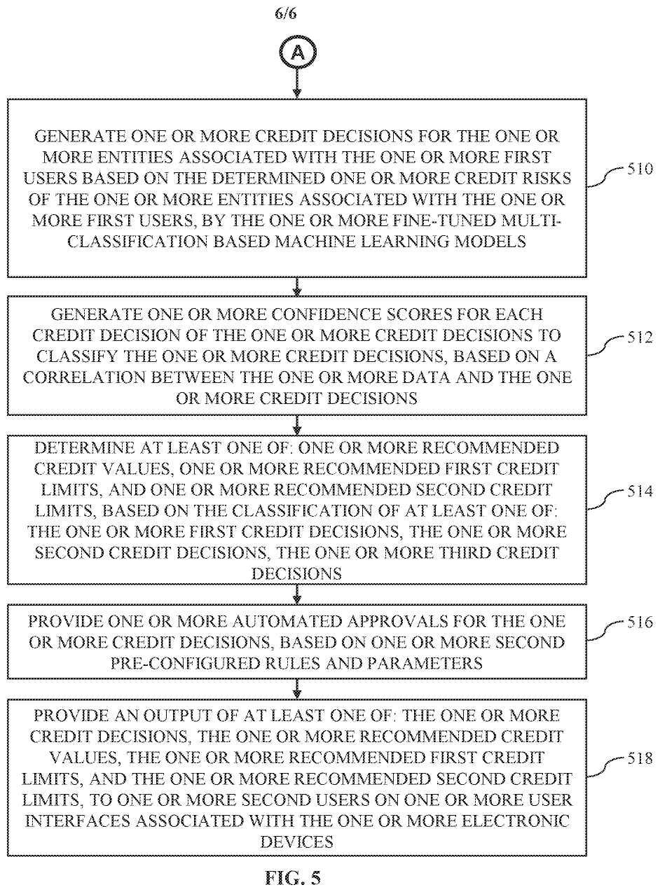

FIG. 5 is an flow chart illustrating a machine-learning based (ML-based) computing method 500 for automatically managing the one or more credit risks of the one or more first users, in accordance with an embodiment of the present disclosure. At step 502, the one or more inputs are received from the one or more electronic devices 102 associated with the one or more second users. In an embodiment, the one or more inputs include the one or more information related to at least one of: the one or more entities associated with the one or more first users.

At step 504, the one or more data associated with the one or more first users are retrieved from the one or more databases 108, based on the one or more inputs received from the one or more electronic devices 102 associated with the one or more second users. The one or more data include at least one of: the one or more credit agency data, the one or more accounts receivables data, the one or more financial metrics, and the one or more entity data, associated with the one or more first users.

At step 506, the one or more data are preprocessed to remove at least one of: the one or more noises, the one or more outliers, and the one or more missing values, from the one or more datasets including the one or more data. In an embodiment, the one or more data are preprocessed to at least one of: normalize and standardize the one or more data to be consistent and compatible based on the one or more first pre-configured rules and parameters.

At step 508, the one or more credit risks of the one or more entities associated with the one or more first users are determined based on the preprocessed one or more data, by the one or more fine-tuned multi-classification based machine learning models.

At step 510, the one or more credit decisions are generated for the one or more entities associated with the one or more first users based on the determined one or more credit risks of the one or more entities associated with the one or more first users, by the one or more fine-tuned multi-classification based machine learning models. The one or more credit decisions include at least one of: the one or more first credit decisions (e.g., the one or more credit upgrade decisions), the one or more second credit decisions (e.g., the one or more credit downgrade decisions), the one or more third credit decisions (e.g., the one or more credit extension decisions).

At step 512, the one or more confidence scores are generated for each credit decision of the one or more credit decisions to classify the one or more credit decisions, based on the correlation between the one or more data and the one or more credit decisions. At step 514, at least one of: the one or more recommended credit values, the one or more recommended first credit limits (e.g., the one or more recommended upper credit limits), and the one or more recommended second credit limits (e.g., the one or more recommended lower credit limits), based on the classification of at least one of: the one or more first credit decisions (e.g., the one or more credit upgrade decisions), the one or more second credit decisions (e.g., the one or more credit downgrade decisions), the one or more third credit decisions (e.g., the one or more credit extension decisions).

At step 516, the one or more automated approvals are provided for the one or more credit decisions, based on the one or more second pre-configured rules and parameters. At step 518, the output of at least one of: the one or more credit decisions, the one or more recommended credit values, the one or more recommended first credit limits, and the one or more recommended second credit limits, are provided to the one or more second users on the one or more user interfaces associated with the one or more electronic devices 102. In FIG. 5, the circular symbol with “A” written inside is being used as an off-page connector. This is used for indicating that FIG. 5 continues in the next page.

The present invention has the following advantages. The present invention with the ML-based computing system 104 is configured for credit risk assessment which can monitor buyer parameters and generate the one or more credit decisions (e.g., the one or more credit upgrade decisions, the one or more credit downgrade decisions, and the one or more credit extension decisions) with at least one of: the one or more recommended credit values, the one or more recommended first credit limits (e.g., the one or more recommended upper credit limits), and the one or more recommended second credit limits (e.g., the one or more recommended lower credit limits), to the one or more second users.

The present invention with the ML-based computing system 104 is configured for the second users (e.g., the organizations) to swiftly identify and mitigate credit exposure to potentially risky buyers at an early stage. Furthermore, the ML-based computing system 104 allows for the proactive identification and rewarding of healthy buyers, fostering a positive client relationship. Further, streamlining the review process and ensuring adherence to supplier compliance goals is expedited.

The present invention with the ML-based computing system 104 is configured for the one or more second users (e.g., credit teams) to gain enhanced control over lending decisions, minimizing delinquencies and promoting proactive collections. Further, the ML-based computing system's 104 ability to optimize days sales outstanding (DSO) contributes to more effective financial management. Ultimately, the proactive credit decisioning facilitated by machine learning empowers the business to expand strategically, armed with robust risk management capabilities.

The written description describes the subject matter herein to enable any person skilled in the art to make and use the embodiments. The scope of the subject matter embodiments is defined by the claims and may include other modifications that occur to those skilled in the art. Such other modifications are intended to be within the scope of the claims if they have similar elements that do not differ from the literal language of the claims or if they include equivalent elements with insubstantial differences from the literal language of the claims.

The embodiments herein can comprise hardware and software elements. The embodiments that are implemented in software include but are not limited to, firmware, resident software, microcode, etc. The functions performed by various modules described herein may be implemented in other modules or combinations of other modules. For the purposes of this description, a computer-usable or computer-readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random-access memory (RAM), a read-only memory (ROM), a rigid magnetic disk and an optical disk. Current examples of optical disks include compact disk-read only memory (CD-ROM), compact disk-read/write (CD-R/W) and DVD.

Input/output (I/O) devices (including but not limited to keyboards, displays, pointing devices, etc.) can be coupled to the ML-based computing system 104 either directly or through intervening I/O controllers. Network adapters may also be coupled to the ML-based computing system 104 to enable the data processing system to become coupled to other data processing systems or remote printers or storage devices through intervening private or public networks. Modems, cable modem and Ethernet cards are just a few of the currently available types of network adapters.

A representative hardware environment for practicing the embodiments may include a hardware configuration of an information handling/ML-based computing system 104 in accordance with the embodiments herein. The ML-based computing system 104 herein comprises at least one processor or central processing unit (CPU). The CPUs are interconnected via the system bus 208 to various devices including at least one of: a random-access memory (RAM), read-only memory (ROM), and an input/output (I/O) adapter. The I/O adapter can connect to peripheral devices, including at least one of: disk units and tape drives, or other program storage devices that are readable by the ML-based computing system 104. The ML-based computing system 104 can read the inventive instructions on the program storage devices and follow these instructions to execute the methodology of the embodiments herein.

The ML-based computing system 104 further includes a user interface adapter that connects a keyboard, mouse, speaker, microphone, and/or other user interface devices including a touch screen device (not shown) to the bus to gather user input. Additionally, a communication adapter connects the bus to a data processing network, and a display adapter connects the bus to a display device which may be embodied as an output device including at least one of: a monitor, printer, or transmitter, for example.

A description of an embodiment with several components in communication with each other does not imply that all such components are required. On the contrary, a variety of optional components are described to illustrate the wide variety of possible embodiments of the invention. When a single device or article is described herein, it will be apparent that more than one device/article (whether or not they cooperate) may be used in place of a single device/article. Similarly, where more than one device or article is described herein (whether or not they cooperate), it will be apparent that a single device/article may be used in place of the more than one device or article, or a different number of devices/articles may be used instead of the shown number of devices or programs. The functionality and/or the features of a device may be alternatively embodied by one or more other devices which are not explicitly described as having such functionality/features. Thus, other embodiments of the invention need not include the device itself.

The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments. Also, the words “comprising,” “having,” “containing,” and “including,” and other similar forms are intended to be equivalent in meaning and be open-ended in that an item or items following any one of these words is not meant to be an exhaustive listing of such item or items or meant to be limited to only the listed item or items. It must also be noted that as used herein and in the appended claims, the singular forms “a,” “an,” and “the” include plural references unless the context clearly dictates otherwise.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that are issued on an application based here on. Accordingly, the embodiments of the present invention are intended to be illustrative, but not limiting, of the scope of the invention, which is set forth in the following claims.

What is claimed is:

1. A machine-learning based (ML-based) computing method for managing one or more credit risks of one or more first users, the ML-based computing method comprising:
receiving, by one or more hardware processors, one or more inputs from one or more electronic devices associated with one or more second users, wherein the one or more inputs comprise one or more information related to at least one of: one or more entities associated with the one or more first users;
retrieving, by the one or more hardware processors, one or more data associated with the one or more first users from one or more databases, based on the one or more inputs received from the one or more electronic devices associated with the one or more second users, wherein the one or more data comprise at least one of: one or more credit agency data, one or more accounts receivables data, one or more financial metrics, and one or more entity data, associated with the one or more first users;
determining, by the one or more hardware processors, the one or more credit risks of the one or more entities associated with the one or more first users based on preprocessed one or more data, by one or more machine learning models;
generating, by the one or more hardware processors, one or more credit decisions for the one or more entities associated with the one or more first users based on the determined one or more credit risks of the one or more entities associated with the one or more first users, by the one or more machine learning models, wherein the one or more credit decisions comprise at least one of: one or more first credit decisions, one or more second credit decisions, one or more third credit decisions;
generating, by the one or more hardware processors, one or more confidence scores for each credit decision of the one or more credit decisions to classify the one or more credit decisions, based on a correlation between the one or more data and the one or more credit decisions, wherein the classification of the one or more credit decisions comprises at least one of: one or more first credit decisions, one or more second credit decisions, one or more third credit decisions;
determining, by the one or more hardware processors, at least one of: one or more recommended credit values, one or more recommended first credit limits, and one or more recommended second credit limits, based on the classification of at least one of: the one or more first credit decisions, the one or more second credit decisions, and the one or more third credit decisions;
providing, by the one or more hardware processors, one or more automated approvals for the one or more credit decisions, based on one or more second pre-configured rules and parameters; and
providing, by the one or more hardware processors, an output of at least one of: the one or more credit decisions, the one or more recommended credit values, the one or more recommended first credit limits, and the one or more recommended second credit limits, to the one or more second users on one or more user interfaces associated with the one or more electronic devices.

2. The machine-learning based (ML-based) computing method of claim 1, further comprising retrieving, by the one or more hardware processors, one or more current credit limits and maintaining the one or more current credit limits, for the one or more entities associated with the one or more first users when the one or more third credit decisions are generated.

3. The machine-learning based (ML-based) computing method of claim 1, wherein at least one of: the one or more recommended first credit limits, and the one or more recommended second credit limits, are determined upon generation of at least one of: the one or more first credit decisions and the one or more second credit decisions, based on one or more key statistical parameters, wherein the one or more key statistical parameters comprise at least one of: the one or more current credit limits, median, and standard deviation, and
wherein the one or more current credit limits are associated with one or more reference points when the median and the standard deviation provide one or more insights into a central tendency and variability of the one or more data.

4. The machine-learning based (ML-based) computing method of claim 3, wherein:
the one or more recommended credit values are determined by adding one or more scaled values of the standard deviation to the one or more current credit limits, with one or more first scaling factors associated with one or more first configurable statistical variables, when the one or more first credit decisions are generated;
the one or more recommended first credit limits are determined by adding the one or more scaled values of the standard deviation to the one or more current credit limits, with one or more second scaling factors associated with one or more second configurable statistical variables, when the one or more first credit decisions are generated; and
the one or more recommended third credit limits are determined by at least one of: adding the one or more scaled values of the standard deviation to the one or more current credit limits, with one or more third scaling factors associated with one or more third configurable statistical variables, when the one or more first credit decisions are generated.

5. The machine-learning based (ML-based) computing method of claim 3, wherein:
the one or more recommended credit values are determined by subtracting the one or more scaled values of the standard deviation to the one or more current credit limits, with the one or more first scaling factors associated with the one or more first configurable statistical variables, when the one or more second credit decisions are generated;
the one or more recommended first credit limits are determined by subtracting the one or more scaled values of the standard deviation to the one or more current credit limits, with the one or more second scaling factors associated with the one or more second configurable statistical variables, when the one or more second credit decisions are generated; and
the one or more recommended third credit limits are determined by at least one of: subtracting the one or more scaled values of the standard deviation to the one or more current credit limits, with the one or more third scaling factors associated with the one or more third configurable statistical variables, when the one or more second credit decisions are generated.

6. The machine-learning based (ML-based) computing method of claim 1, further comprising training, by the one or more hardware processors, the one or more machine learning models, by:
obtaining, by the one or more hardware processors, one or more labelled datasets from the one or more databases, wherein the one or more labelled datasets comprise the one or more data;
selecting, by the one or more hardware processors, one or more features associated with the one or more data for training the one or more machine learning models based on one or more feature engineering processes,
wherein the one or more feature engineering processes comprise at least one of: a forward feature selection process, a backward feature selection process, an exhaustive feature selection process, a recursive feature elimination process, a random forest importance process and a boosted feature extractor process;
segmenting, by the one or more hardware processors, the one or more labelled datasets into at least one of: one or more training datasets and one or more validation datasets;
training, by the one or more hardware processors, the one or more machine learning models to correlate the one or more features associated with the one or more data, with one or more historical credit decisions,
wherein the one or more historical credit decisions comprises at least one of: one or more first historical credit decision, one or more second historical credit decisions, one or more third historical credit decisions, and
wherein the one or more machine learning models comprise at least one of: a random forest model, an extreme gradient boosting (XGBoost) classifier model, a K-means clustering model, a light gradient-boosting machine (LightGBM) classifier model; and
generating, by the one or more hardware processors, the one or more confidence scores for each credit decision of the one or more credit decisions, based on the trained one or more machine learning models.

7. The machine-learning based (ML-based) computing method of claim 6, further comprising validating, by the one or more hardware processors, the one or more machine learning models based on the one or more validation datasets, wherein validating the one or more machine learning models comprises:
determining, by the one or more hardware processors, whether one or more metric scores attained by the trained machine learning model, exceeds one or more pre-determined threshold values, wherein the one or more metric scores are associated with one or more validation metrics comprising at least one of: precision metric, recall metric, and F1-score metric.

8. The machine-learning based (ML-based) computing method of claim 7, further comprising adjusting, by the one or more hardware processors, one or more hyperparameters to fine-tune the one or more machine learning models based on one or more results of validation of the one or more machine learning models.

9. The machine-learning based (ML-based) computing method of claim 6, further comprising re-training, by the one or more hardware processors, the one or more machine learning models over a plurality of time intervals based on one or more training data, wherein re-training the one or more machine learning models over the plurality of time intervals comprises;
receiving, by the one or more hardware processors, the one or more training data corresponding to the one or more data associated with the one or more second users;
adding, by the one or more hardware processors, the one or more training data with the one or more labelled datasets to generate one or more updated training datasets;
re-training, by the one or more hardware processors, the one or more machine learning models to correlate the one or more features associated with the one or more data, with the one or more historical credit decisions; and
executing, by the one or more hardware processors, the re-trained one or more machine learning models in a credit decision generation subsystem to generate the one or more credit decisions for the one or more entities associated with the one or more first users.

10. A machine learning based (ML-based) computing system for managing one or more credit risks of one or more first users, the ML-based computing system comprising:
one or more hardware processors;
a memory coupled to the one or more hardware processors, wherein the memory comprises a plurality of subsystems in form of programmable instructions executable by the one or more hardware processors, and wherein the plurality of subsystems comprises:
an input receiving subsystem configured to receive one or more inputs from one or more electronic devices associated with one or more second users, wherein the one or more inputs comprise one or more information related to at least one of: one or more entities associated with the one or more first users;
a data retrieval subsystem configured to retrieve one or more data associated with the one or more first users from one or more databases, based on the one or more inputs received from the one or more electronic devices associated with the one or more second users, wherein the one or more data comprise at least one of: one or more credit agency data, one or more accounts receivables data, one or more financial metrics, and one or more entity data, associated with the one or more first users;
a credit risk determining subsystem configured to determine the one or more credit risks of the one or more entities associated with the one or more first users based on preprocessed one or more data, by one or more machine learning models;
a credit decision generation subsystem configured to generate one or more credit decisions for the one or more entities associated with the one or more first users based on the determined one or more credit risks of the one or more entities associated with the one or more first users, by the one or more machine learning models, wherein the one or more credit decisions comprise at least one of: one or more first credit decisions, one or more second credit decisions, one or more third credit decisions;
a confidence score generation subsystem configured to generate one or more confidence scores for each credit decision of the one or more credit decisions to classify the one or more credit decisions, based on a correlation between the one or more data and the one or more credit decisions, wherein the classification of the one or more credit decisions comprises at least one of one or more first credit decisions, one or more second credit decisions, one or more third credit decisions;
a credit limit determining subsystem configured to determine at least one of: one or more recommended credit values, one or more recommended first credit limits, and one or more recommended second credit limits, based on the classification of at least one of: the one or more first credit decisions, the one or more second credit decisions, and the one or more third credit decisions;
an auto-approval subsystem configured to provide one or more automated approvals for the one or more credit decisions, based on one or more second pre-configured rules and parameters; and
an output subsystem configured to provide an output of at least one of: the one or more credit decisions, the one or more recommended credit values, the one or more recommended first credit limits, and the one or more recommended second credit limits, to one or more second users on one or more user interfaces associated with the one or more electronic devices.

11. The machine-learning based (ML-based) computing system of claim 10, wherein the credit limit determining subsystem is further configured to retrieve one or more current credit limits and to maintain the one or more current credit limits, for the one or more entities associated with the one or more first users when the one or more third credit decisions are generated.

12. The machine-learning based (ML-based) computing system of claim 10, wherein at least one of; the one or more recommended first credit limits, and the one or more recommended second credit limits, are determined upon generation of at least one of: the one or more first credit decisions and the one or more second credit decisions, based on one or more key statistical parameters, wherein the one or more key statistical parameters comprise at least one of: the one or more current credit limits, median, and standard deviation, and
wherein the one or more current credit limits are associated with one or more reference points when the median and the standard deviation provide one or more insights into a central tendency and variability of the one or more data.

13. The machine-learning based (ML-based) computing system of claim 12, wherein:
the one or more recommended credit values are determined by adding one or more scaled values of the standard deviation to the one or more current credit limits, with one or more first scaling factors associated with one or more first configurable statistical variables, when the one or more first credit decisions are generated;
the one or more recommended first credit limits are determined by adding the one or more scaled values of the standard deviation to the one or more current credit limits, with one or more second scaling factors associated with one or more second configurable statistical variables, when the one or more first credit decisions are generated; and
the one or more recommended third credit limits are determined by at least one of adding the one or more scaled values of the standard deviation to the one or more current credit limits, with one or more third scaling factors associated with one or more third configurable statistical variables, when the one or more first credit decisions are generated.

14. The machine-learning based (ML-based) computing system of claim 12, wherein:
the one or more recommended credit values are determined by subtracting the one or more scaled values of the standard deviation to the one or more current credit limits, with the one or more first scaling factors associated with the one or more first configurable statistical variables, when the one or more second credit decisions are generated;
the one or more recommended first credit limits are determined by subtracting the one or more scaled values of the standard deviation to the one or more current credit limits, with the one or more second scaling factors associated with the one or more second configurable statistical variables, when the one or more second credit decisions are generated; and
the one or more recommended third credit limits are determined by at least one of: subtracting the one or more scaled values of the standard deviation to the one or more current credit limits, with the one or more third scaling factors associated with the one or more third configurable statistical variables, when the one or more second credit decisions are generated.

15. The machine-learning based (ML-based) computing method of claim 10, further comprising a training subsystem configured to train the one or more machine learning models, wherein in training the one or more machine learning models, the training subsystem is configured to:
obtain one or more labelled datasets from the one or more databases, wherein the one or more labelled datasets comprise the one or more data;
select one or more features associated with the one or more data for training the one or more machine learning models based on one or more feature engineering processes,
wherein the one or more feature engineering processes comprise at least one of: a forward feature selection process, a backward feature selection process, an exhaustive feature selection process, a recursive feature elimination process, a random forest importance process and a boosted feature extractor process;
segment the one or more labelled datasets into at least one of: one or more training datasets and one or more validation datasets;
train the one or more machine learning models to correlate the one or more features associated with the one or more data, with one or more historical credit decision,
wherein the one or more historical credit decisions comprises at least one of: one or more first historical credit decision, one or more second historical credit decisions, one or more third historical credit decisions, and
wherein the one or more machine learning models comprise at least one of: a random forest model, an extreme gradient boosting (XGBoost) classifier model, a K-means clustering model, a light gradient-boosting machine (LightGBM) classifier model; and
generate the one or more confidence scores for each credit decision of the one or more credit decisions, based on the trained one or more machine learning models.

16. The machine-learning based (ML-based) computing system of claim 15, wherein the training subsystem is further configured to validate the one or more machine learning models based on the one or more validation datasets, and wherein in validating the one or more machine learning models, the training subsystem is configured to:
determine whether one or more metric scores attained by the trained machine learning model, exceeds one or more pre-determined threshold values, wherein the one or more metric scores are associated with one or more validation metrics comprising at least one of: precision metric, recall metric, and F1-score metric.

17. The machine-learning based (ML-based) computing system of claim 16, wherein the training subsystem is further configured to adjust one or more hyperparameters to fine-tune the one or more machine learning models based on one or more results of validation of the one or more machine learning models.

18. The machine-learning based (ML-based) computing system of claim 10, wherein the training subsystem is further configured to re-train the one or more machine learning models over a plurality of time intervals based on one or more training data, wherein in re-training the one or more machine learning models over the plurality of time intervals, the training subsystem is configured to:
receive the one or more training data corresponding to the one or more data associated with the one or more second users;
add the one or more training data with the one or more labelled datasets to generate one or more updated training datasets;
re-train the one or more machine learning models to correlate the one or more features associated with the one or more data, with the one or more historical credit decisions; and
execute the re-trained one or more machine learning models in a credit decision generation subsystem to generate the one or more credit decisions for the one or more entities associated with the one or more first users.

19. A non-transitory computer-readable storage medium having instructions stored therein that when executed by one or more hardware processors, cause the one or more hardware processors to execute operations of:
receiving one or more inputs from one or more electronic devices associated with one or more second users, wherein the one or more inputs comprise one or more information related to at least one of: one or more entities associated with the one or more first users;
retrieving one or more data associated with the one or more first users from one or more databases, based on the one or more inputs received from the one or more electronic devices associated with the one or more second users, wherein the one or more data comprise at least one of: one or more credit agency data, one or more accounts receivables data, one or more financial metrics, and one or more entity data, associated with the one or more first users;
determining the one or more credit risks of the one or more entities associated with the one or more first users based on preprocessed one or more data, by one or more machine learning models;
generating one or more credit decisions for the one or more entities associated with the one or more first users based on the determined one or more credit risks of the one or more entities associated with the one or more first users, by the one or more machine learning models, wherein the one or more credit decisions comprise at least one of: one or more first credit decisions, one or more second credit decisions, one or more third credit decisions;
generating one or more confidence scores for each credit decision of the one or more credit decisions to classify the one or more credit decisions, based on a correlation between the one or more data and the one or more credit decisions, wherein the classification of the one or more credit decisions comprises at least one of: one or more first credit decisions, one or more second credit decisions, one or more third credit decisions;
determining at least one of: one or more recommended credit values, one or more recommended first credit limits, and one or more recommended second credit limits, based on the classification of at least one of: the one or more first credit decisions, the one or more second credit decisions, and the one or more third credit decisions;
providing one or more automated approvals for the one or more credit decisions with at least one of: the one or more recommended credit values, the one or more recommended first credit limits, and the one or more recommended second credit limits, based on one or more second pre-configured rules and parameters; and
providing an output of at least one of: the one or more credit decisions, the one or more recommended credit values, the one or more recommended first credit limits, and the one or more recommended second credit limits, to one or more second users on one or more user interfaces associated with the one or more electronic devices.

20. The non-transitory computer-readable storage medium of claim 19, further comprising training the one or more machine learning models, by:
obtaining one or more labelled datasets from the one or more databases, wherein the one or more labelled datasets comprise the one or more data;
selecting one or more features associated with the one or more data for training the one or more machine learning models based on one or more feature engineering processes,
wherein the one or more feature engineering processes comprise at least one of: a forward feature selection process, a backward feature selection process, an exhaustive feature selection process, a recursive feature elimination process, a random forest importance process and a boosted feature extractor process;
segmenting the one or more labelled datasets into at least one of: one or more training datasets and one or more validation datasets;
training the one or more machine learning models to correlate the one or more features associated with the one or more data, with one or more historical credit decisions,
wherein the one or more historical credit decisions comprises at least one of: one or more first historical credit decision, one or more second historical credit decisions, one or more third historical credit decisions, and
wherein the one or more machine learning models comprise at least one of: a random forest model, an extreme gradient boosting (XGBoost) classifier model, a K-means clustering model, a light gradient-boosting machine (LightGBM) classifier model; and
generating the one or more confidence scores for each credit decision of the one or more credit decisions, based on the trained one or more machine learning models.
